(19) United States
(12) Patent Application Publication
(10) Pub. No.: US 2008/0261095 A1
(43) Pub. Date: Oct. 23, 2008

(54) Membrane-Electrode Assembly, Method for Manufacturing the Same, and Fuel Cell

(76) Inventors: Masaki Yamauchi, Osaka (JP); Yoshihiro Hori, Nara (JP); Yasuo Takebe, Kyoto (JP); Yasuhiro Seki, Osaka (JP)

Correspondence Address: MCDERMOTT WILL & EMERY LLP, 600 13TH STREET, NW, WASHINGTON, DC, 20005-3096, US

(21) Appl. No.: 11/993,303

(22) PCT Filed: Jun. 19, 2006
(86) PCT No.: PCT/JP2006/312234

§ 371 Date: Dec. 20, 2007

(30) Foreign Application Priority Data
Jun. 20, 2005 (JP) 2005-179926

(51) Int. Cl. H01M 8/10; H01M 6/00

(52) U.S. Cl. 429/30; 29/623.1

(57) ABSTRACT

A membrane-electrode assembly (1) of the present invention comprises: a quadrate polymer electrolyte membrane (2); a pair of catalyst layers provided to sandwich the polymer electrolyte membrane except for a peripheral portion of the polymer electrolyte membrane; and a pair of gas diffusion layers (3) provided respectively on the pair of the catalyst layers, the membrane-electrode assembly (1) being incorporated into a fuel cell by being sandwiched between a pair of separators on each of which a reaction gas passage (A) or (C) is concavely formed in a gas diffusion layer contacting region of an inner surface thereof, the gas diffusion layer contacting region being a region contacting the gas diffusion layer, wherein: each of the reaction gas passages (A) and (C) in the gas diffusion layer contacting region is formed to have a serpentine shape which extends from upstream to downstream in a direction from a first side (2a) of the polymer electrolyte membrane 1 to a third side (2c) facing the first side along a second side (2b) adjacent to the first side while turning in directions along the first side; reinforced portions (4) for reinforcing the polymer electrolyte membrane are formed at a portion corresponding to the second side and a portion corresponding to a fourth side (2d) facing the second side in the peripheral portion of the polymer electrolyte membrane 2; and the reinforced portion (4) is not formed at a portion corresponding to at least the third side (2c) in the peripheral portion of the polymer electrolyte membrane (2).

### TECHNICAL FIELD

The present invention relates to a membrane-electrode assembly, a method for manufacturing the membrane-electrode assembly, and a fuel cell which incorporates therein the membrane-electrode assembly, and particularly to a reinforced structure of a peripheral portion of a polymer electrolyte membrane.

### BACKGROUND ART

Generally, a fuel cell is constructed by stacking a large number of cells, and each cell is constructed by sandwiching a membrane-electrode assembly (MEA) between a pair of electrically-conductive separators together with gaskets provided at a peripheral portion of the membrane-electrode assembly. The membrane-electrode assembly includes a polymer electrolyte membrane and a pair of electrodes provided to sandwich the polymer electrolyte membrane except for a peripheral portion of the polymer electrolyte membrane. Each electrode is constituted of a catalyst layer formed on the polymer electrolyte membrane and a gas diffusion layer provided on the catalyst layer. A reaction gas passage is concavely formed in a region (hereinafter referred to as “gas diffusion layer contacting region”) of an inner surface of each separator, the region contacting the gas diffusion layer of the membrane-electrode assembly. A fuel gas is supplied to the reaction gas passage of one of the separators as a reaction gas, an oxidizing gas is supplied to the reaction gas passage of the other separator as the reaction gas, and chemical reactions occur in respective electrodes. This generates electricity together with heat.

Regarding this conventional fuel cell, it is known that a portion of the polymer electrolyte membrane on which a peripheral portion of the electrode is formed deteriorates. Proposed as a countermeasure is reinforcing the peripheral portion of the polymer electrolyte membrane (see Patent Document 1 for example).

Patent Document 1: Japanese Unexamined Patent Application Publication No. 10-308228

### DISCLOSURE OF THE INVENTION

### Problems to be Solved by the Invention

However, in accordance with the fuel cell of Patent Document 1, it was actually difficult to efficiently manufacture the membrane-electrode assembly. To be specific, in accordance with the fuel cell of Patent Document 1, since the peripheral portion of the polymer electrolyte membrane is entirely reinforced, it is impossible to continuously reinforce the master roll of the polymer electrolyte membrane. In accordance with the fuel cell of Patent Document 1, after the master roll is cut into membrane pieces (hereinafter referred to as “polymer electrolyte membrane pieces”) used for the membrane-electrode assembly, the polymer electrolyte membrane pieces are reinforced individually. Therefore, it was impossible to efficiently manufacture the membrane-electrode assembly.

The present invention was made to solve the above problems, and an object of the present invention is to provide a membrane-electrode assembly capable of being manufactured efficiently, a method for manufacturing the membrane-electrode assembly, and a fuel cell which incorporates the fuel cell.

### Means for Solving the Problems

The present inventors have diligently studied to solve the above problems. As a result, the following finding was obtained.

FIG. 9 is a schematic diagram showing a positional relation between reaction gas passages and a cooling water passage of separators and a membrane-electrode assembly when viewed from a thickness direction of the membrane-electrode assembly in a fuel cell for studies. In FIG. 9, each of the passages 202 to 204 is shown by a single line, but is actually constituted of a plurality of passages.

As shown in FIG. 9, when viewed from a thickness direction of a membrane-electrode assembly 200, reaction gas passages 202 and 203 and a cooling water passage 204 are formed in a region inside a gas diffusion layer 3 so as to be serpentine shapes which are in parallel with each other (to be precise, passages extending between turned portions are in parallel with each other) in light of preventing flooding and drying of the polymer electrolyte membrane. In this fuel cell, the shape in plan view (to be precise, the cross-section of a cell stack) of a polymer electrolyte membrane 201 constituting the membrane-electrode assembly 200 is a rectangular quadrangle, and two sides facing each other and remaining two sides facing each other of the polymer electrolyte membrane 201 extend in a vertical direction and a horizontal direction, respectively. Each of the passages 202 to 204 is formed to have a serpentine shape which extends in a direction from an upper side 201a to a lower side 201c along a right side 201b (left side 201d) while turning in directions along the upper side 201a of the polymer electrolyte membrane. Therefore, reaction gases and cooling water flow in each cell from top to bottom while serpentining in a lateral direction. Therefore, the relation between the flow of an anode gas and the flow of a cathode gas is so-called parallel flow. Moreover, the peripheral portion of the polymer electrolyte membrane 201 is not reinforced.

In such fuel cell, after an endurance test (continuous electric power generation operation under predetermined conditions) was carried out, the distribution of leakage rates (hereinafter referred to as “gas leakage rates”) of gas (to be precise, hydrogen) on a main surface of the membrane-electrode assembly 201 was measured. Thus, data shown in FIG. 10 was obtained. FIG. 10 is a graph showing the distribution of the gas leakage rates on the main surface of the membrane-electrode assembly 201 of the fuel cell used for studies.

Referring to FIGS. 10 and 9, the gas leakage rates are high at the peripheral portion of the polymer electrolyte membrane 201. Especially, the gas leakage rates are high at portions corresponding to the right side 201b and the left side 201d. In contrast, the gas leakage rates are low at a portion corresponding to the lower side 201c, and are somewhat high at a portion corresponding to the upper side 201a. Since the gas leakage rate increases as the polymer electrolyte membrane deteriorates, the distribution of the gas leakage rates can be regarded as showing the distribution of deterioration of the polymer electrolyte membrane.

The reason why the deterioration of the portions corresponding to the right side 201b and the left side 201d of the peripheral portion of the polymer electrolyte membrane 201 is large is as follows. Since these portions (especially, an outer peripheral portion of the gas diffusion layer 3) contact the turned portions of the reaction gas passages 202 and 203 of the separators, a portion contacting the passage of the separator and a portion contacting a portion where the passage of the separator is not provided exist alternately in a direction along the right side 201b and the left side 201d. Therefore, guessingly, pressure applied to the polymer electrolyte membrane 201 by the fastening force of the cell stack becomes non-uniform in a direction along the right side 201b and the left side 201d, so that the deterioration of portions to which high pressure is applied becomes large. In contrast, the reason why the deterioration of the portions corresponding to the upper side 201a and the lower side 201c of the peripheral portion of the polymer electrolyte membrane 201 is small is as follows. Since these portions contact straight portions extending between turns of the reaction gas passages 202 and 203, any one of the portion contacting the passage of the separator and the portion contacting the portion where the passage of the separator is not provided exists in a direction along the upper side 201a and the lower side 201c, and these portions do not exist alternately. Therefore, guessingly, the pressure applied to the polymer electrolyte membrane 201 by the fastening force of the cell stack becomes uniform in a direction along the upper side 201a and the lower side 201c, so that the deterioration of the portions becomes small. Further, the reason why the deterioration of the portion corresponding to the lower side 201c of the peripheral portion of the polymer electrolyte membrane 201 is especially small is as follows. Guessingly, since the portion contacts downstream portions of the reaction gas passages 202 and 203, and the portion is adequately humidified by moisture generated by reactions of the reaction gases, the deterioration of the portion is especially small.

In accordance with this finding, it is revealed that it is necessary to form a reinforced portion at the peripheral portion corresponding to two sides of four sides of the polymer electrolyte membrane, the two sides being located along the turned portions of the serpentine-shaped reaction gas passage which are oriented in a column and formed on the separator, and it is unnecessary to form the reinforced portion at the peripheral portion corresponding to one side of the remaining two sides, the side being located along the downstream portions of the reaction gas passages.

Thus, the present inventors have made the present invention having the following constructions based on this finding.

A membrane-electrode assembly of the present invention comprises: a quadrate polymer electrolyte membrane; a pair of catalyst layers provided to sandwich the polymer electrolyte membrane except for a peripheral portion of the polymer electrolyte membrane; and a pair of gas diffusion layers provided respectively on the pair of the catalyst layers, the membrane-electrode assembly being incorporated into a fuel cell by being sandwiched between a pair of separators on each of which a reaction gas passage is concavely formed in a gas diffusion layer contacting region of an inner surface thereof, the gas diffusion layer contacting region being a region contacting the gas diffusion layer, wherein: on each of the separators, the reaction gas passage in the gas diffusion layer contacting region is formed to have a serpentine shape which extends from upstream to downstream in a direction from a side (hereinafter referred to as “first side”) of the polymer electrolyte membrane to a side (hereinafter referred to as “third side”) facing the first side along a side (hereinafter referred to as “second side”) adjacent to the first side while turning in directions along the first side; and reinforced portions for reinforcing the polymer electrolyte membrane are formed at a portion corresponding to the second side and a portion corresponding to a side (hereinafter referred to as “fourth side”) facing the second side in the peripheral portion of the polymer electrolyte membrane, and the reinforced portion is not formed at a portion corresponding to at least the third side in the peripheral portion of the polymer electrolyte membrane.

The reinforced portions may be formed only at the portion corresponding to the second side and the portion corresponding to the fourth side in the peripheral portion of the polymer electrolyte membrane.

The reinforced portion may be further formed at a portion corresponding to the first side in the peripheral portion of the polymer electrolyte membrane.

The polymer electrolyte membrane may include a membrane-like core on which a large number of through holes are formed and polymer electrolyte layers formed respectively on both surfaces of the core so as to fill the through holes, and the reinforced portions may be constituted of high-strength portions each of which is formed by forming the polymer electrolyte layer on a region of the core on which region the through holes are not formed.

The reinforced portion may be constituted of reinforcing members provided respectively on both surfaces of the polymer electrolyte membrane.

The reinforced portions formed at the portion corresponding to the second side and the portion corresponding to the fourth side in the peripheral portion of the polymer electrolyte membrane may be constituted of the high-strength portions, and the reinforced portion may be formed at the portion corresponding to the first side in the peripheral portion of the polymer electrolyte membrane such that reinforcing members are provided respectively on both surfaces of the polymer electrolyte membrane.

A fuel cell of the present invention comprises a plurality of stacked cells, each cell including: a membrane-electrode assembly having: a quadrate polymer electrolyte membrane; a pair of catalyst layers provided to sandwich the polymer electrolyte membrane except for a peripheral portion of the polymer electrolyte membrane; and a pair of electrically-conductive gas diffusion layers provided respectively on the pair of the catalyst layers; and a pair of separators on each of which a reaction gas passage is concavely formed in a gas diffusion layer contacting region of an inner surface thereof and which sandwich the membrane-electrode assembly such that the gas diffusion layer contacting region contacts the gas diffusion layer, wherein: on each of the separators, the reaction gas passage in the gas diffusion layer contacting region is formed to have a serpentine shape which extends from upstream to downstream in a direction from a side (hereinafter referred to as “first side”) of the polymer electrolyte membrane to a side (hereinafter referred to as “third side”) facing the first side along a side (hereinafter referred to as “second side”) adjacent to the first side while turning in directions along the first side; and reinforced portions for reinforcing the polymer electrolyte membrane are formed at a portion corresponding to the second side and a portion corresponding to a side (hereinafter referred to as “fourth side”) facing the second side in the peripheral portion of the polymer electrolyte membrane, and the reinforced portion is not formed at a portion corresponding to at least the third side in the peripheral portion of the polymer electrolyte membrane.

A method for manufacturing a membrane-electrode assembly of the present invention is a method for manufacturing a membrane-electrode assembly including: a quadrate polymer electrolyte membrane; a pair of catalyst layers provided to sandwich the polymer electrolyte membrane except for a peripheral portion of the polymer electrolyte membrane; and a pair of electrically-conductive gas diffusion layers provided respectively on the pair of the catalyst layers, the method comprising the steps of: preparing an elongate membrane-like core having a predetermined width; forming, on the core, a through hole formed region where a through hole penetrating in a thickness direction of the core is formed and a through hole non-formed region where the through hole is not substantially formed such that the through hole non-formed region forms a pair of strips respectively extending along both ends of the core, and the through hole formed region is located at a portion other than the through hole non-formed region; forming polymer electrolyte layers respectively on both surfaces of the core on which the through hole non-formed region and the through hole formed region are formed such that the polymer electrolyte layer fills the through hole, and forming an elongate polymer electrolyte membrane having a pair of high-strength portions which are formed by forming the polymer electrolyte layers respectively on the pair of the through hole non-formed regions; cutting the elongate polymer electrolyte membrane to form a membrane piece-shaped polymer electrolyte membrane having a predetermined length; and forming the pair of the catalyst layers and the pair of the gas diffusion layers respectively on both surfaces of the membrane piece-shaped polymer electrolyte membrane such that at least part of the catalyst layers and at least part of the gas diffusion layers are located between the pair of the high-strength portions.

A method for manufacturing a membrane-electrode assembly of the present invention is a method for manufacturing a membrane-electrode assembly including: a quadrate polymer electrolyte membrane; a pair of catalyst layers provided to sandwich the polymer electrolyte membrane except for a peripheral portion of the polymer electrolyte membrane; and a pair of electrically-conductive gas diffusion layers provided respectively on the pair of the catalyst layers, the method comprising the steps of: (A) preparing an elongate membrane-like core having a predetermined width; (B) forming, on the core, through hole formed regions where a through hole penetrating in a thickness direction of the core is formed and through hole non-formed regions where the through hole is not substantially formed such that the through hole non-formed regions extend in a width direction of the core so as to have a strip shape, the through hole non-formed regions are arranged at a predetermined pitch in a longitudinal direction of the core, and the through hole formed regions are arranged at portions other than the through hole non-formed regions; (C) forming polymer electrolyte layers respectively on both surfaces of the core on which the through hole non-formed regions and the through hole formed regions are formed such that the polymer electrolyte layer fills the through hole, and forming an elongate polymer electrolyte membrane having a plurality of high-strength portions which are formed by forming the polymer electrolyte layers on the plurality of the through hole non-formed regions; (D) cutting the elongate polymer electrolyte membrane at the plurality of the high-strength portions to form membrane piece-shaped polymer electrolyte membranes each of which includes a pair of the high-strength portions respectively at a pair of sides each having a length corresponding to the predetermined pitch and formed by the above cutting; and (E) forming the pair of the catalyst layers and the pair of the gas diffusion layers respectively on both surfaces of the membrane piece-shaped polymer electrolyte membrane such that at least part of the catalyst layers and at least part of the gas diffusion layers are located between the pair of the high-strength portions.

The method may further comprise the step of: (F) between the steps (C) and (D), providing a tape-shaped reinforcing member along at least one side end of the polymer electrolyte membrane, wherein: in the step (D), by cutting the elongate polymer electrolyte membrane at the plurality of the high-strength portions, the membrane piece-shaped polymer electrolyte membranes may be formed, each of which includes a pair of the high-strength portions respectively at a pair of sides each having a length corresponding to the predetermined pitch and formed by the above cutting and also includes the reinforcing member which is provided along a side between the pair of the sides and both of whose ends are cut; and in the step (E), the pair of the catalyst layers and the pair of the gas diffusion layers may be formed respectively on both surfaces of the membrane piece-shaped polymer electrolyte membrane such that at least part of the catalyst layers and at least part of the gas diffusion layers are located among the pair of the high-strength portions and the reinforcing member.

A membrane-electrode assembly of the present invention comprises: a quadrate polymer electrolyte membrane; a pair of catalyst layers provided to sandwich the polymer electrolyte membrane except for a peripheral portion of the polymer electrolyte membrane; and a pair of gas diffusion layers provided respectively on the pair of the catalyst layers, the membrane-electrode assembly being incorporated into a fuel cell by being sandwiched between a pair of separators on each of which a reaction gas passage is concavely formed in a gas diffusion layer contacting region of an inner surface thereof, the gas diffusion layer contacting region being a region contacting the gas diffusion layer, wherein a reinforced portion is not formed at a portion corresponding to a side extending along a downstream portion of the reaction gas passage in the peripheral portion of the polymer electrolyte membrane.

Moreover, the present inventors have examined the deterioration of the polymer electrolyte membrane in a case where the flows of the reaction gases are so-called counter flow. As a result, in the case of the counter flow, it is revealed that a portion corresponding to an upstream portion of an anode gas passage and a portion corresponding to an upstream portion of a cathode gas passage deteriorate largely in the peripheral portion of the rectangular polymer electrolyte membrane.

A membrane-electrode assembly of the present invention comprises: a quadrate polymer electrolyte membrane; a pair of catalyst layers provided to sandwich the polymer electrolyte membrane except for a peripheral portion of the polymer electrolyte membrane; and a pair of electrically-conductive gas diffusion layers provided respectively on the pair of the catalyst layers, the membrane-electrode assembly being incorporated into a fuel cell by being sandwiched between a pair of separators on each of which a reaction gas passage is concavely formed in a gas diffusion layer contacting region of an inner surface thereof, the gas diffusion layer contacting region being a region contacting the gas diffusion layer, wherein: on one of the separators, the reaction gas passage in the gas diffusion layer contacting region is formed to have a serpentine shape which extends from upstream to downstream in a direction from a side (hereinafter referred to as “first side”) of the polymer electrolyte membrane to a side (hereinafter referred to as “third side”) facing the first side along a side (hereinafter referred to as “second side”) adjacent to the first side while turning in directions along the first side; on the other separator, the reaction gas passage in the gas diffusion layer contacting region is formed to have a serpentine shape which extends from upstream to downstream in a direction from the third side of the polymer electrolyte membrane to the first side along a side (hereinafter referred to as “fourth side”) facing the second side while turning in directions along the third side; and reinforced portions for reinforcing the polymer electrolyte membrane are formed at a portion corresponding to the first side and a portion corresponding to the third side in the peripheral portion of the polymer electrolyte membrane, and the reinforced portion is not formed at a portion corresponding to the second side or a portion corresponding to the fourth side in the peripheral portion of the polymer electrolyte membrane. Further, the present inventors have examined the deterioration of the polymer electrolyte membrane in a case where the flows of the reaction gases are so-called cross flow. As a result, in the case of the cross flow, it is revealed that the portion corresponding to the upstream portion of the anode gas passage and the portion corresponding to the upstream of the cathode gas passage deteriorate largely in the peripheral portion of the rectangular polymer electrolyte membrane.

A membrane-electrode assembly of the present invention comprises: a quadrate polymer electrolyte membrane; a pair of catalyst layers provided to sandwich the polymer electrolyte membrane except for a peripheral portion of the polymer electrolyte membrane; and a pair of electrically-conductive gas diffusion layers provided respectively on the pair of the catalyst layers, the membrane-electrode assembly being incorporated into a fuel cell by being sandwiched between a pair of separators on each of which a reaction gas passage is concavely formed in a gas diffusion layer contacting region of an inner surface thereof, the gas diffusion layer contacting region being a region contacting the gas diffusion layer, wherein: on one of the separators, the reaction gas passage in the gas diffusion layer contacting region is formed to have a serpentine shape which extends from upstream to downstream in a direction from a side (hereinafter referred to as “first side”) of the polymer electrolyte membrane to a side (hereinafter referred to as “third side”) facing the first side along a side (hereinafter referred to as “second side”) adjacent to the first side while turning in directions along the first side; on the other separator, the reaction gas passage in the gas diffusion layer contacting region is formed to have a serpentine shape which extends from upstream to downstream in a direction from the second side of the polymer electrolyte membrane to a side (hereinafter referred to as “fourth side”) facing the second side along the first side while turning in directions along the second side; and reinforced portions for reinforcing the polymer electrolyte membrane are formed at a portion corresponding to the first side and a portion corresponding to the second side in the peripheral portion of the polymer electrolyte membrane, and the reinforced portion is not formed at a portion corresponding to the third side or a portion corresponding to the fourth side in the peripheral portion of the polymer electrolyte membrane. Moreover, a method for manufacturing a membrane-electrode assembly of the present invention is a method for manufacturing a membrane-electrode assembly including: a quadrate polymer electrolyte membrane; a pair of catalyst layers provided to sandwich the polymer electrolyte membrane except for a peripheral portion of the polymer electrolyte membrane; and a pair of electrically-conductive gas diffusion layers provided respectively on the pair of the catalyst layers, the method comprising the steps of: preparing an elongate membrane-like core having a predetermined width; forming, on the core, through hole formed regions where a through hole penetrating in a thickness direction of the core is formed and through hole non-formed regions where the through hole is not substantially formed such that the through hole non-formed regions extend in a width direction of the core so as to have a strip shape, the through hole non-formed regions are arranged at a predetermined pitch in a longitudinal direction of the core, and the through hole formed regions are arranged at portions other than the through hole non-formed regions; forming polymer electrolyte layers respectively on both surfaces of the core on which the through hole non-formed regions and the through hole formed regions are formed such that the polymer electrolyte layer fills the through hole, and forming an elongate polymer electrolyte membrane having a plurality of high-strength portions which are formed by forming the polymer electrolyte layers on the plurality of the through hole non-formed regions; providing a tape-shaped reinforcing member along one side end of the polymer electrolyte membrane; cutting the elongate polymer electrolyte membrane at portions in the vicinity of the plurality of the high-strength portions to form membrane piece-shaped polymer electrolyte membranes each of which includes the high-strength portion along a side having a length corresponding to the predetermined pitch and formed by the above cutting and also includes the reinforcing member which is provided along a side adjacent to the above side and both of whose ends are cut; and forming the pair of the catalyst layers and the pair of the gas diffusion layers respectively on both surfaces of the membrane piece-shaped polymer electrolyte membrane such that at least part of the catalyst layers and at least part of the gas diffusion layers are located among the high-strength portion, the reinforcing member and sides facing the high-strength portion and the reinforcing member.

The above object, other objects, features, and advantages of the present invention will be made clear by the following detailed explanation of preferred embodiments with reference to the attached drawings.

### EFFECTS OF THE INVENTION

The present invention can provide a membrane-electrode assembly having the above-described construction and capable of being manufactured efficiently, a method for manufacturing the membrane-electrode assembly, and a fuel cell which incorporates therein the membrane-electrode assembly.

### BRIEF DESCRIPTION OF THE DRAWINGS

FIG. 1 is a schematic diagram showing a positional relation between reaction gas passages and a cooling water passage of separators and a membrane-electrode assembly of Embodiment 1 of the present invention when viewed from a thickness direction of the membrane-electrode assembly.

FIG. 2 are diagrams showing the construction of the membrane-electrode assembly of FIG. 1. FIG. 2(a) is a plan view, and FIG. 2(b) is a cross-sectional view showing a cross-section taken along line IIB-IIB of FIG. 2(a).

FIGS. 3(a) and 3(b) are schematic diagrams showing steps of manufacturing the membrane-electrode assembly of Embodiment 1 of the present invention.

FIG. 4 are diagrams showing the construction of a membrane-electrode assembly of Embodiment 2 of the present invention. FIG. 4(a) is a plan view, and FIG. 4(b) is a cross-sectional view showing a cross-section taken along line IVB-IVB of FIG. 4(a).

FIGS. 5(a) and 5(b) are schematic diagrams showing steps of manufacturing the membrane-electrode assembly of Embodiment 2 of the present invention.

FIGS. 6(a) and 6(b) are schematic diagrams showing steps of manufacturing the membrane-electrode assembly of Embodiment 2 of the present invention.

FIG. 7 are diagrams showing the construction of a membrane-electrode assembly of Embodiment 3 of the present invention. FIG. 7(a) is a plan view, FIG. 7(b) is a cross-sectional view showing a cross-section taken along line VIIB-VIIB of FIG. 7(a), and FIG. 7(c) is a cross-sectional view showing a cross-section taken along line VIIC-VIIC of FIG. 7(a).

FIG. 8 is a partially exploded perspective view showing the construction of a fuel cell of Embodiment 4 of the present invention.

FIG. 9 is a schematic diagram showing a positional relation between reaction gas passages and a cooling water passage of separators and a membrane-electrode assembly when viewed from a thickness direction of the membrane-electrode assembly in a fuel cell used for studying problems of the present invention.

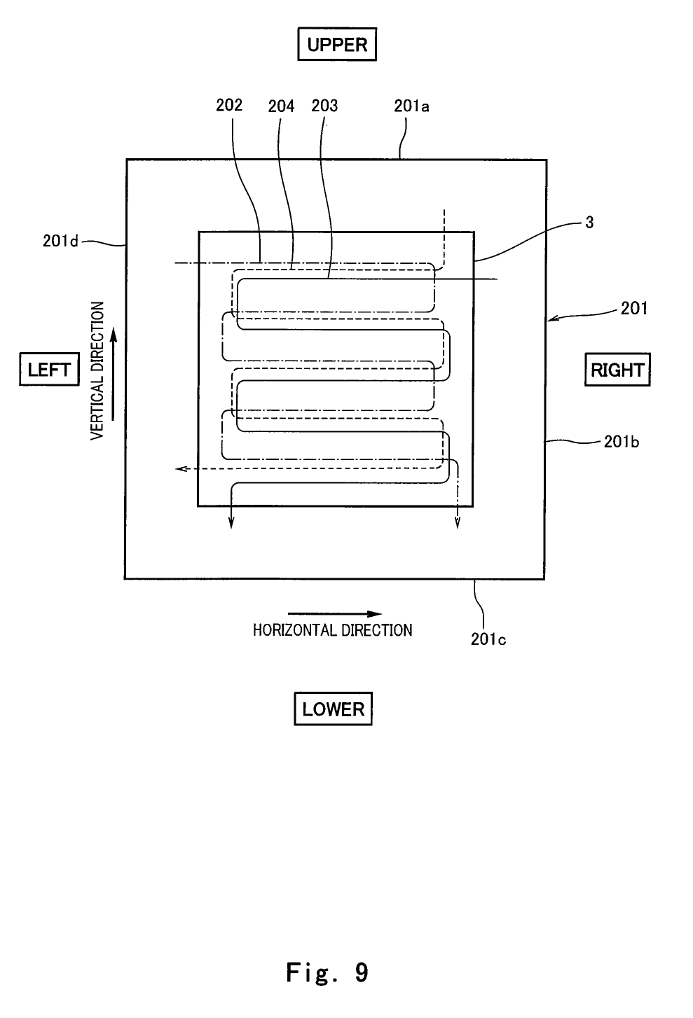

FIG. 10 is a graph showing a distribution of gas leakage rates on a main surface of the membrane-electrode assembly of the fuel cell used for studying problems of the present invention.

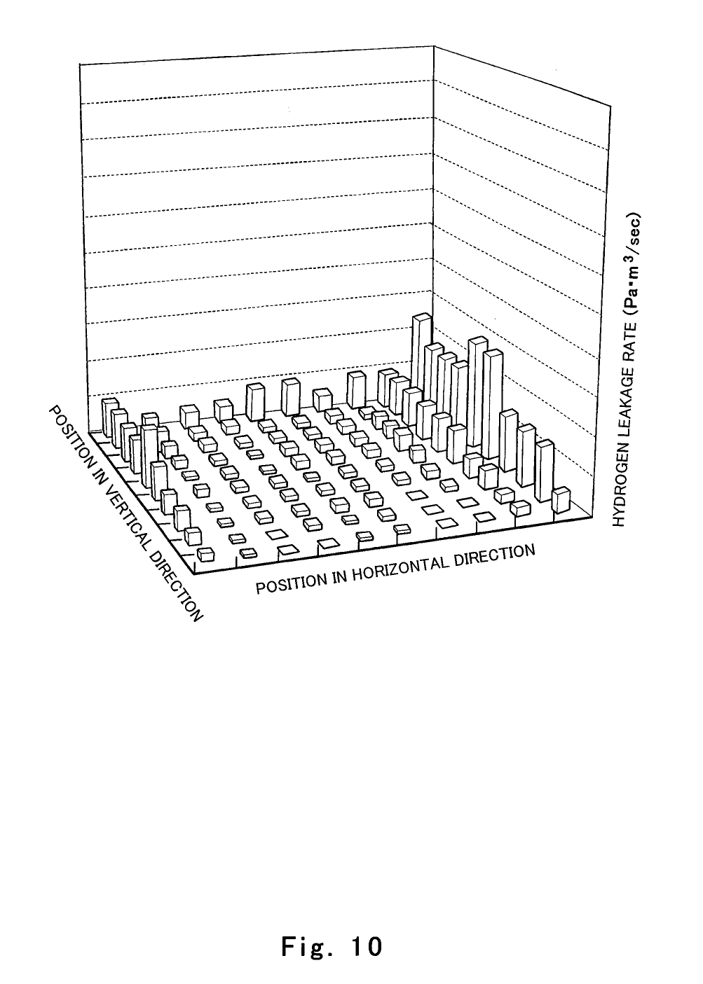

FIG. 11 are diagrams showing the construction of a membrane-electrode assembly of Embodiment 5 of the present invention. FIG. 11(a) is a plan view, FIG. 11(b) is a cross-sectional view showing a cross-section taken along line XIB-XIB of FIG. 11(a), and FIG. 11(c) is a cross-sectional view showing a cross-section taken along line XIC-XIC of FIG. 11(a).

FIG. 12 are diagrams showing the construction of a membrane-electrode assembly of Embodiment 6 of the present invention. FIG. 12(a) is a plan view, FIG. 12(b) is a cross-sectional view showing a cross-section taken along line XIIB-XIOIB of FIG. 12(a), and FIG. 12(c) is a cross-sectional view showing a cross-section taken along line XIIC-XIIC of FIG. 12(a).

FIG. 13 are diagrams showing the construction of a membrane-electrode assembly of Embodiment 7 of the present invention. FIG. 13(a) is a plan view, FIG. 13(b) is a cross-sectional view showing a cross-section taken along line XIIIB-XIIIB of FIG. 13(a), and FIG. 13(c) is a cross-sectional view showing a cross-section taken along line XIIIC-XIIIC of FIG. 13(a).

FIG. 14 is a schematic diagram showing a positional relation between reaction gas passages and a cooling water passage of separators and a membrane-electrode assembly of Embodiment 8 of the present invention when viewed from a thickness direction of the membrane-electrode assembly.

FIGS. 15(a) and 15(b) are schematic diagrams showing steps of manufacturing the membrane-electrode assembly of Embodiment 8 of the present invention.

FIG. 16 is a schematic diagram showing a positional relation between reaction gas passages and a cooling water passage of separators and a membrane-electrode assembly of Embodiment 9 of the present invention when viewed from a thickness direction of the membrane-electrode assembly.

FIGS. 17(a) and 17(b) are schematic diagrams showing steps of manufacturing the membrane-electrode assembly of Embodiment 9 of the present invention.

FIGS. 18(a) and 18(b) are schematic diagrams showing steps of manufacturing a membrane-electrode assembly of Embodiment 10 of the present invention.

FIGS. 19(a) and 19(b) are schematic diagrams showing steps of manufacturing a membrane-electrode assembly of Embodiment 11 of the present invention.

### EXPLANATION OF REFERENCE NUMBERS

1 membrane-electrode assembly
2 polymer electrolyte membrane
2a to 2d side of the polymer electrolyte membrane
3 gas diffusion layer
4 reinforced portion
5 catalyst layer
6 reinforcing member
7A, 7B gasket
8A anode separator
8B cathode separator
9 cell
10 current collector
11 end plate
21A fuel gas supplying manifold hole
21B fuel gas discharging manifold hole
22A oxidizing gas supplying manifold hole
22B oxidizing gas discharging manifold hole
23A cooling water supplying manifold hole
23B cooling water discharging manifold hole
51 core
51a through hole non-formed region
51b through hole formed region
52 roll
53 roll
54 roll
101 fuel cell
103 direction in which a serpentine-shaped passage macroscopically extends
104 direction intersecting the direction in which the serpentine-shaped passage macroscopically extends
201 polymer electrolyte membrane
201a to 201d side of the polymer electrolyte membrane
202, 203 reaction gas passage
204 cooling water passage
A fuel gas passage
C oxidizing gas passage
W cooling water passage

### BEST MODE FOR CARRYING OUT THE INVENTION

Hereinafter, preferred embodiments of the present invention will be explained with reference to the drawings.

### Embodiment 1

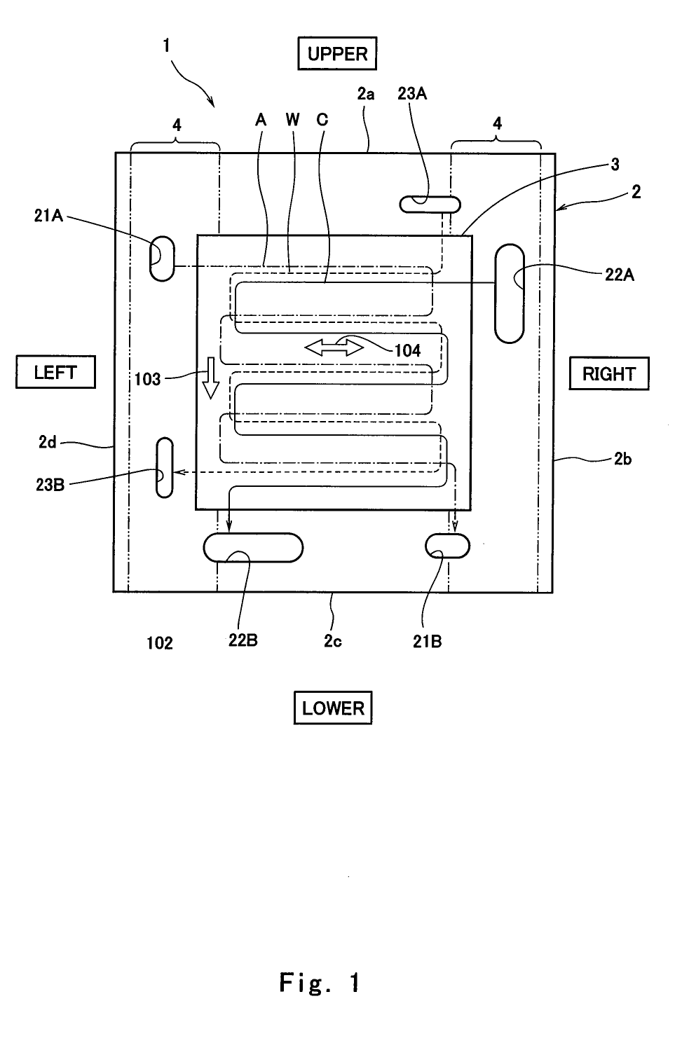

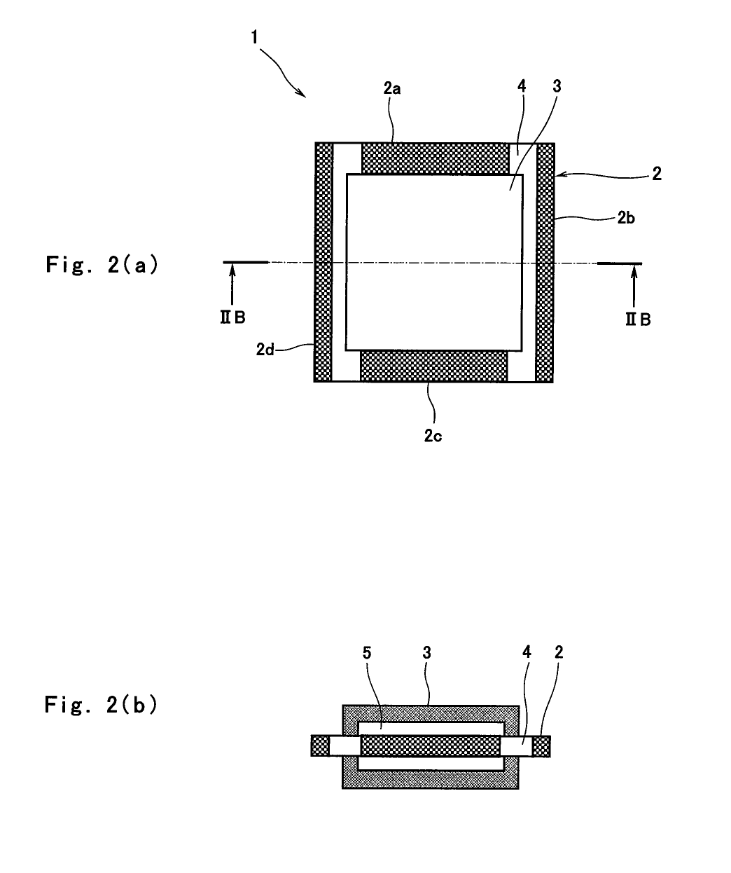

FIG. 1 is a schematic diagram showing a positional relation between reaction gas passages and a cooling water passage of separators and a membrane-electrode assembly of Embodiment 1 of the present invention when viewed from a thickness direction of the membrane-electrode assembly. FIG. 2 are diagrams showing the construction of the membrane-electrode assembly of FIG. 1. FIG. 2(a) is a plan view, and FIG. 2(b) is a cross-sectional view showing a cross-section taken along line IIB-IIB of FIG. 2(a).

As shown in FIGS. 2(a) and 2(b), a membrane-electrode assembly 1 of the present embodiment includes a polymer electrolyte membrane 2. A pair of catalyst layers 5 are formed respectively on both surfaces of the polymer electrolyte membrane 2 except for a peripheral portion of the polymer electrolyte membrane 2, and a pair of gas diffusion layers 3 are respectively formed on the pair of the catalyst layers 5. The gas diffusion layers 3 are provided to also cover end surfaces of the catalyst layers 5, respectively. The catalyst layer 5 and the gas diffusion layer 3 constitute an electrode.

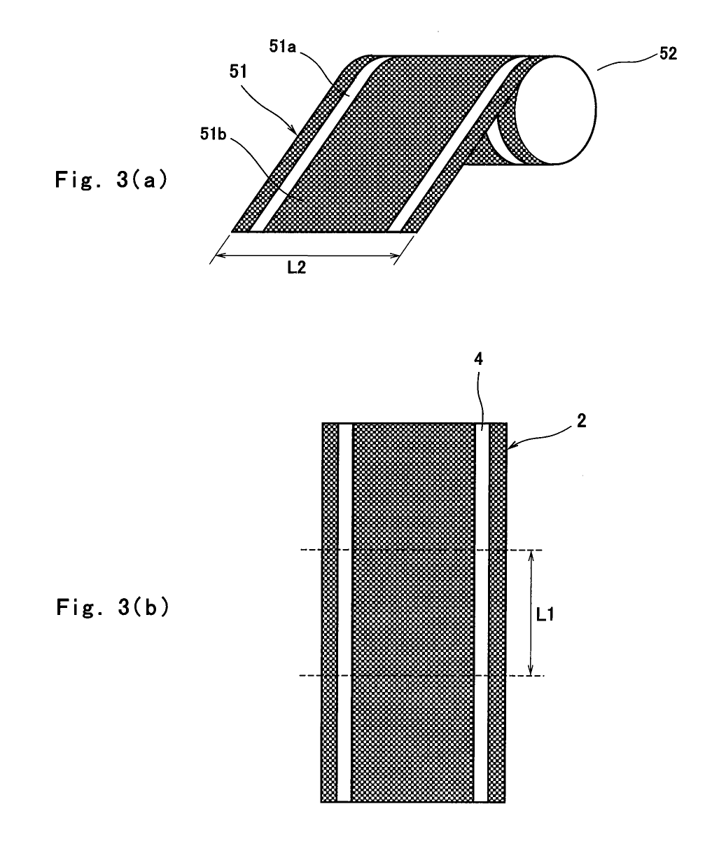

The polymer electrolyte membrane (to be precise, polymer electrolyte membrane piece) 2 is constructed by forming polymer electrolyte layers respectively on both surfaces of a membrane-like core (core 51 shown in FIG. 3), on which a large number of through holes are formed, such that the polymer electrolyte layer fills the through holes. Preferably used as the material of the core is, for example, polyphenyl sulfide (PPS). In a case where the core is made of PPS, through holes (through bores) extending in a thickness direction of the membrane-like core are formed on the membrane-like core by punching. Preferably used as the material of the polymer electrolyte layer is, for example, an electrolyte having proton conductivity, such as perfluoro sulfonic acid. In FIGS. 2(a) and 2(b), colored portions of the polymer electrolyte membrane 2 are portions where the through bores are formed on the core, that is, non-reinforced portions. In contrast, non-colored portions 4 of the polymer electrolyte membrane 2 are portions where the through bores are not formed on the core, that is, reinforced portions. Since the through bore is not formed on the high-strength portion 4, the strength of the high-strength portion 4 is not lowered by the formation of the through bore, and has an original strength of the core. The high-strength portion 4 is formed in the shape of a strip extending along two facing sides 2b and 2d of the polymer electrolyte membrane 2. The arrangement of the high-strength portion 4 will be described later. A peripheral portion of the gas diffusion layer 3 is formed on the high-strength portion 4 of the polymer electrolyte membrane 2. Of course, the peripheral portion of the gas diffusion layer 3 does not have to be formed on the high-strength portion 4.

The catalyst layer 5 is constituted of, for example, an electrically-conductive carrier carrying a catalyst, such as platinum. Preferably used as the material of the electrically-conductive carrier are, for example, ketjen and acetylene black.

The gas diffusion layer 3 is constituted of a porous conductor. Preferably used as the porous conductor are, for example, carbon nonwoven fabric and carbon paper.

Next, the arrangement of the high-strength portion 4 of the polymer electrolyte membrane 2 will be explained in detail.

In FIG. 1, in the fuel cell (Embodiment 4) using the membrane-electrode assembly 1 of the present embodiment, the cross-section of a cell stack is a rectangular quadrangle, so that the shape in plan view of the polymer electrolyte membrane 2 constituting the membrane-electrode assembly 1 is also a rectangular quadrangle. The fuel cell is disposed such that two sides facing each other and remaining two sides facing each other of the polymer electrolyte membrane 2 extend in a vertical direction and a horizontal direction, respectively. Hereinafter, for convenience sake, respective sides of the polymer electrolyte membrane 2 are referred to as an upper side 2a (first side), a right side 2b (second side), a lower side 2c (third side) and a left side 2d (fourth side) in accordance with directions shown in FIG. 1.

FIG. 1 shows an appearance of the placed membrane-electrode assembly 1 when viewed from a rear surface (cathode-side main surface) of the membrane-electrode assembly 1. In FIG. 1, reaction gas passages A and C and a cooling water passage W formed on respective separators are shown to overlap the appearance of the rear surface of the membrane-electrode assembly 1. In FIG. 1, each of the reaction gas passages A and C and the cooling water passage W is shown by a single line, but is actually constituted of a plurality of passages.

A cooling water supplying manifold hole 23A is formed at a right-side portion of an upper end portion of the polymer electrolyte membrane 2. An oxidizing gas supplying manifold hole 22A is formed at an upper-side portion of a right end portion of the polymer electrolyte membrane 2. A fuel gas discharging manifold hole 21B is formed at a right-side portion of a lower end portion of the polymer electrolyte membrane 2, and an oxidizing gas discharging manifold hole 22B is formed at a left-side portion of the lower end portion of the polymer electrolyte membrane 2. A fuel gas supplying manifold hole 21A is formed at an upper-side portion of a left end portion of the polymer electrolyte membrane 2, and a cooling water discharging manifold hole 23B is formed at a lower-side portion of the left end portion of the polymer electrolyte membrane 2.

Respective separators are provided with manifold holes corresponding to the manifold holes 21A to 23B. By connecting the manifold holes of the polymer electrolyte membrane 2 and the separators, a fuel gas supplying manifold, a fuel gas discharging manifold, an oxidizing gas supplying manifold, an oxidizing gas discharging manifold, a cooling water supplying manifold and a cooling water discharging manifold are formed.

On an inner surface (surface contacting the membrane-electrode assembly 1) of an anode separator, a fuel gas passage A is formed as one of the reaction gas passages so as to extend from the fuel gas supplying manifold hole to the fuel gas discharging manifold hole. On an outer surface (surface opposite the inner surface) of the anode separator, a cooling water passage W is formed to extend from the cooling water supplying manifold hole to the cooling water discharging manifold hole.

On an inner surface (surface contacting the membrane-electrode assembly 1) of a cathode separator, an oxidizing gas passage C is formed as the other reaction gas passage so as to extend from the oxidizing gas supplying manifold hole to the oxidizing gas discharging manifold hole. On an outer surface (surface opposite the inner surface) of the cathode separator, a cooling water passage W is formed to extend from the cooling water supplying manifold hole to the cooling water discharging manifold hole.

Each of the fuel gas passage A, the oxidizing gas passage C and the cooling water passage W is formed to have a serpentine shape in a region inside the gas diffusion layer 3 when viewed from a thickness direction of the membrane-electrode assembly 1. In the present invention, a serpentine-shaped passage refers to a passage formed to microscopically curve to intersect with a direction 103 and macroscopically extend in the direction 103. In the present embodiment, the serpentine-shaped passage is formed to microscopically repeat a section which extends in a direction orthogonal to the vertical direction (direction along the right side 2b and the left side 2d) 103, that is, a lateral direction (direction along the upper side 2a and the lower side 2c) 104 for a predetermined distance, turns there, extends from there in a direction opposite the above direction along the lateral direction for a predetermined distance and turns there, and macroscopically extend in the vertical direction 103.

In light of preventing the flooding and the drying of the polymer electrolyte membrane, portions of the passages A, C and W extending between the turned portions are formed to be in parallel with each other. Note that flow directions of fluids in the portions of the passages A, C and W extending between the turned portions may be the same as each other or opposite to each other. Moreover, the portions of the passages extending between the turned portions may not be orthogonal to the direction 103 in which the passage macroscopically extends.

In the present embodiment, the reaction gas and the cooling water flow, in each cell, from the respective supplying manifolds to the respective passages A and C, flow from top to bottom while serpentining in the lateral direction, and are discharged from the respective discharging manifolds. In the present invention, such relation between the flow of the anode gas and the flow of the cathode gas is referred to as “parallel flow” (the term is generally used).

In the present embodiment, the high-strength portions 4 of the polymer electrolyte membrane are respectively formed in the shape of a strip extending along the right side 2b and the left side 2d that are sides along the turned portions of the serpentine-shaped passages A, C and W which are oriented in a column.

With this construction, since the strength of the peripheral portion (to be precise, the portion around the gas diffusion layer 3 (electrode)) of the polymer electrolyte membrane 2 which portion deteriorates largely in the endurance test and corresponds to the right side 2b and the left side 2d that are sides along the turned portions of the serpentine-shaped passages A, C and W which are oriented in a column is reinforced by the high-strength portions 4, it is possible to reduce the deterioration of the polymer electrolyte membrane 2. Moreover, since the reinforced portion decreases compared to the case where the peripheral portion of the polymer electrolyte membrane 2 is entirely reinforced, it is possible to efficiently manufacture the membrane-electrode assembly 1.

Next, a method for manufacturing the membrane-electrode assembly 1 constructed as above will be explained.

FIGS. 3(a) and 3(b) are schematic diagrams showing steps of manufacturing the membrane-electrode assembly of the present embodiment.

To manufacture the membrane-electrode assembly, first, a large number of through bores are formed on a master film of the core 51 by punching. The unprocessed core 51 is rolled up to be a roll (not shown), punching is carried out while pulling out the rolled core, and the processed core 51 is rolled to be a roll 52. The core 51 is processed (slit) to have a predetermined width (width of the polymer electrolyte membrane piece: length of the upper side 2a (lower side 2c)) L2. When punching, the through bores are not formed in predetermined strip-shaped regions 51a extending along both edges of the core 51, but are formed in the other region (hereinafter referred to as “through hole formed region”) 51b (FIG. 3(a)). The regions (hereinafter referred to as “through hole non-formed region”) 51a where the through bores are not formed are regions which become the high-strength portions 4 shown in FIG. 2.

Next, the polymer electrolyte layers are formed respectively on both surfaces of the core 51 so as to fill the through bores. Also in this step, the unprocessed core is pulled out from the roll, and is rolled after the processing. Thus, the polymer electrolyte membrane 2 having the strip-shaped high-strength portions 4 is manufactured.

Next, as shown in FIG. 3(b), while the polymer electrolyte membrane 2 is pulled out from the roll, it is cut to have a predetermined length (length of the polymer electrolyte membrane piece: the left side 2d (right side 2b)) L1. Thus, the rectangular membrane piece-shaped polymer electrolyte membrane 2 is formed.

Next, as shown in FIGS. 2(a) and 2(b), the catalyst layer 5 and the gas diffusion layer 3 are sequentially formed on each of both surfaces of the rectangular membrane piece-shaped polymer electrolyte membrane 2. A detailed explanation of this step is omitted since the step is well known. Next, the anode gas supplying manifold hole 21A, the anode gas discharging manifold hole 21B, the cathode gas supplying manifold hole 22A, the cathode gas discharging manifold hole 22B, the cooling water supplying manifold hole 23A and the cooling water discharging manifold hole 23B are formed at predetermined positions of the peripheral portion of the rectangular membrane piece-shaped polymer electrolyte membrane 2.

Thus, the membrane-electrode assembly 1 is manufactured.

In accordance with the above method for manufacturing the membrane-electrode assembly, since the high-strength portions 4 can be formed consecutively on the master film of the polymer electrolyte membrane 2 before cutting into membrane pieces (polymer electrolyte membrane pieces) used for the membrane-electrode assembly 1, it is possible to efficiently manufacture the membrane-electrode assembly 1.

### MODIFICATION EXAMPLE 1

In the present modification example, the core 51 is constituted of a porous “GORE-SELECT (II)” (Product Name) produced by Japan Gore-Tex, Inc. In the step shown in FIG. 3(a), instead of punching, by causing a pair of heating rollers to sandwich a predetermined region of the core 51 to press the region, voids (holes) in the predetermined region of the core 51 are crushed, thereby forming the through hole non-formed region 51a (high-strength portion 4). The present modification example can obtain the same effects as above.

### MODIFICATION EXAMPLE 2

In the present modification example, the core 51 is made of porous polytetrafluoroethylene (PTFE). In the step shown in FIG. 3(a), instead of punching, first, portions (two portions in the width direction of the core 51, strip-shaped regions 51a shown in FIG. 3(a)) which become the through hole non-formed regions 51a (high-strength portions 4) of the core 51 are fixed by fixing means, the core 51 is extended in the width direction (here, portions other than the strip-shaped regions 51a are extended), and then the fixing is canceled and the core 51 is extended in a longitudinal direction by a pair of pressure rollers (here, both the strip-shaped regions 51a and the regions 51b that are regions other than the strip-shaped regions 51a shown in FIG. 3(a) are extended). Thus, since the portions fixed by the fixing means are extended only in the longitudinal direction of the core, the thickness of the strip-shaped region 51a can be made larger than that of the region 51b. Therefore, the mechanical strength of the strip-shaped region 51a (region corresponding to the peripheral portion of the polymer electrolyte membrane 2) can be made higher than that of the region 51b. The present modification example can also obtain the effects of the present invention.

As above, in the present embodiment, since the high-strength portions 4 are formed only at portions corresponding to two facing sides in the peripheral portion of the polymer electrolyte membrane, the master roll of the polymer electrolyte membrane 2 can be processed to be reinforced. Therefore, it is possible to efficiently manufacture the membrane-electrode assembly. Moreover, since the reinforced portion of the peripheral portion of the polymer electrolyte membrane decreases, it is possible to efficiently manufacture the membrane-electrode assembly.

### Embodiment 2

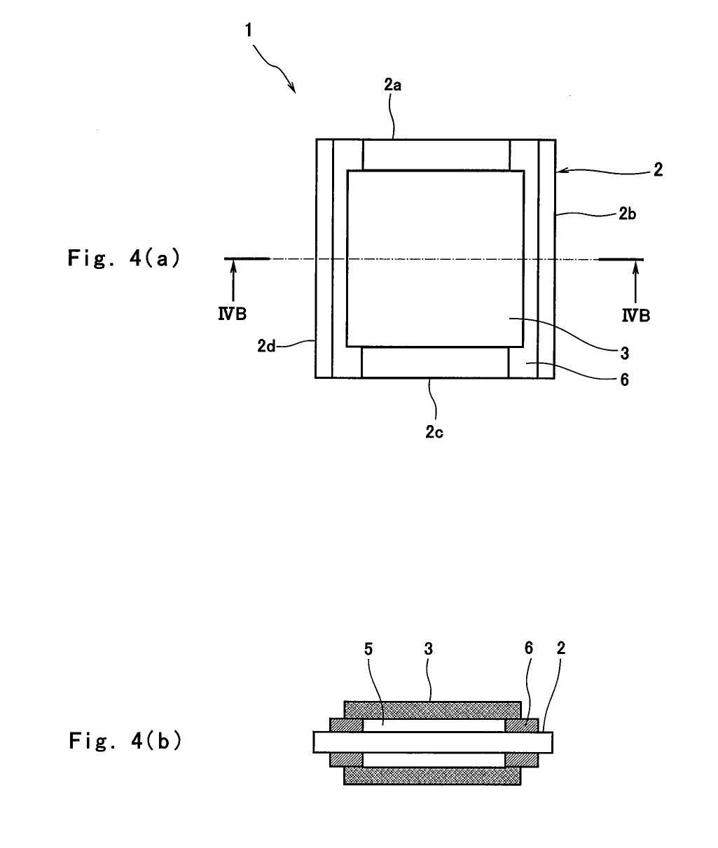

FIG. 4 are diagrams showing the construction of a membrane-electrode assembly of Embodiment 2 of the present invention. FIG. 4(a) is a plan view, and FIG. 4(b) is a cross-sectional view showing a cross-section taken along line IVB-IVB of FIG. 4(a). In FIG. 4, reference numbers that are the same as those in FIG. 2 denote the same or corresponding portions.

As shown in FIG. 4, in the membrane-electrode assembly 1 of the present embodiment, the polymer electrolyte membrane 2 is reinforced by a reinforcing member 6 instead of the high-strength portion 4 of Embodiment 1. Features other than this are the same as those of Embodiment 1.

Specifically, the polymer electrolyte membrane 2 is constituted of a polymer electrolyte membrane which does not include therein a core. A pair of plate-shaped reinforcing members 6 each having a predetermined width are respectively provided to extend along the right side 2b and the left side 2d at portions corresponding to the right side 2b and the left side 2d in the peripheral portion of the polymer electrolyte membrane 2. A pair of the reinforcing members 6 are formed respectively on both surfaces of the polymer electrolyte membrane 2. The catalyst layer 5 is formed such that both edges thereof contact a pair of the reinforcing members 6, respectively. The gas diffusion layer 3 is provided on the catalyst layer 5 and part of the reinforcing members 6. Preferably used as the material of the reinforcing member 6 is, for example, a resin, such as PPS and PTFE.

Next, a method for manufacturing the membrane-electrode assembly constructed as above will be explained.

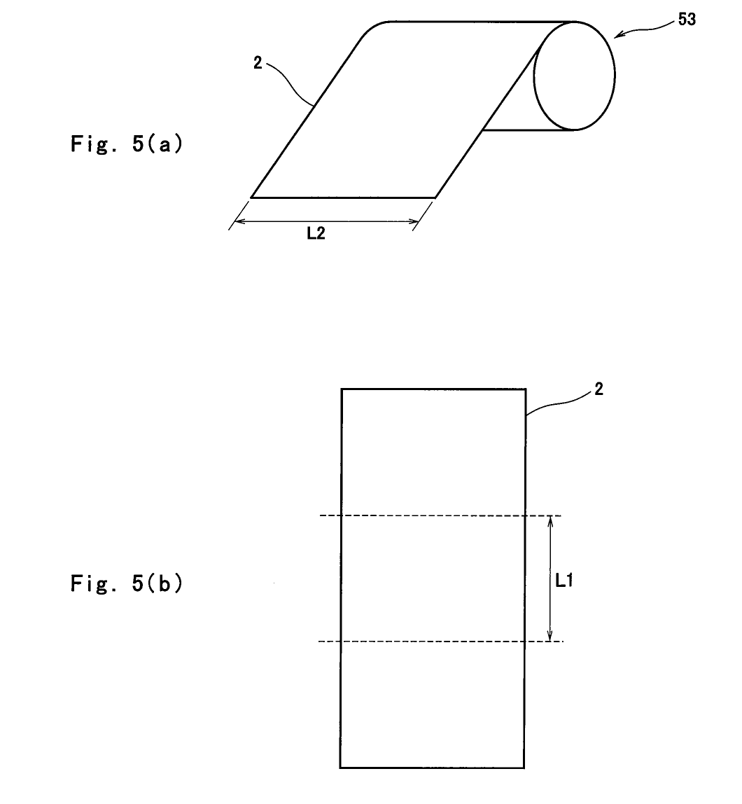

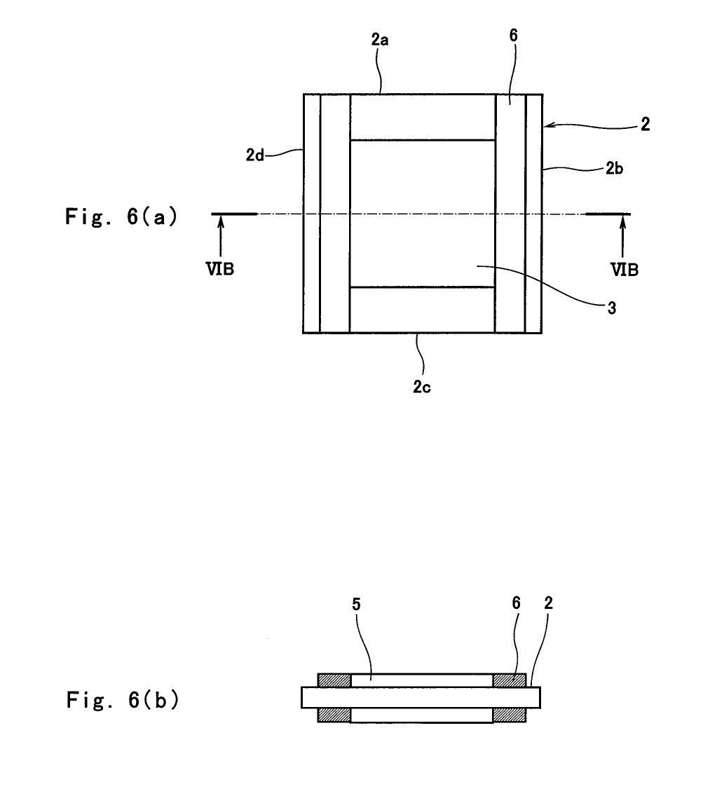

FIGS. 5(a), 5(b), 6(a) and 6(b) are schematic diagrams showing steps of manufacturing the membrane-electrode assembly of the present embodiment.

In the present embodiment, first, as shown in FIG. 5(a), the polymer electrolyte membrane 2 is processed (slit) into a master film having the predetermined width (width of the polymer electrolyte membrane piece) L2, and then is rolled to be a roll 53. Next, as shown in FIG. 5(b), the polymer electrolyte membrane 2 is pulled out from the roll 53, and is cut to have the predetermined length (length of the polymer electrolyte membrane piece) L1.

Next, as shown in FIGS. 6(a) and 6(b), a pair of the catalyst layers 5 are formed respectively on both surfaces of the membrane piece-shaped polymer electrolyte membrane (polymer electrolyte membrane piece) 2. Then, a pair of the reinforcing members 6 are provided to respectively contact both sides (ends in the lateral direction) of each catalyst layer 5. Specifically, the tape-shaped reinforcing member 6 is provided by cutting to have a predetermined length and being bonded to the polymer electrolyte membrane 2.

Next, as shown in FIGS. 4(a) and 4(b), the gas diffusion layer 3 is provided on the catalyst layer 5 and part of the reinforcing members 6.

In accordance with the present embodiment explained as above, since the reinforced portion of the peripheral portion of the polymer electrolyte membrane decreases compared to the case where the peripheral portion of the polymer electrolyte membrane is entirely reinforced, it is possible to efficiently manufacture the membrane-electrode assembly 1.

### Embodiment 3

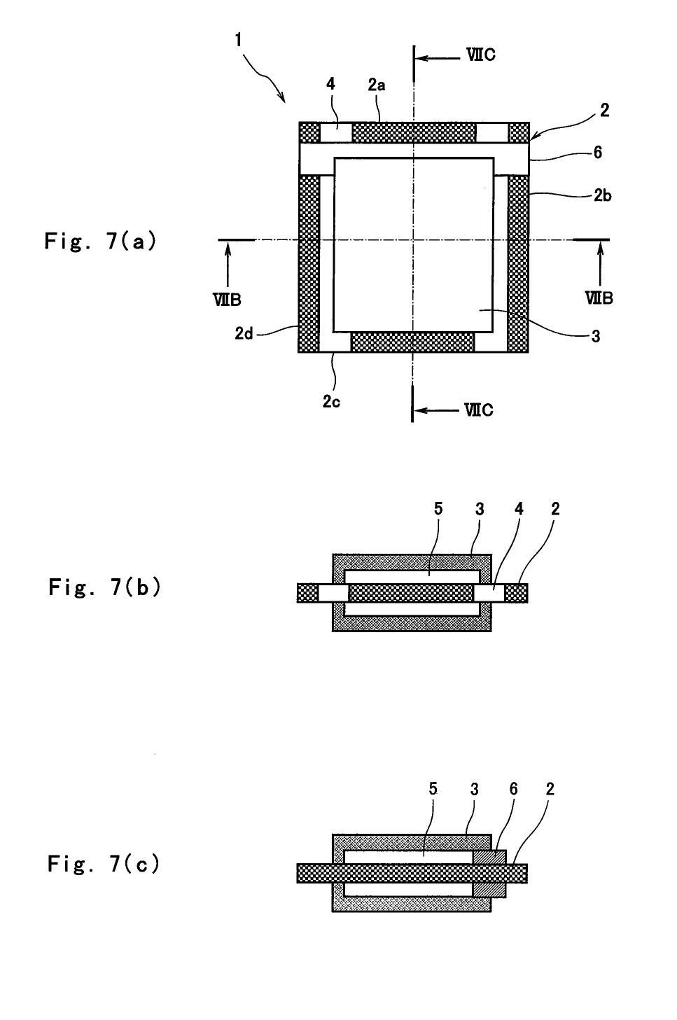

FIG. 7 are diagrams showing the construction of a membrane-electrode assembly of Embodiment 3 of the present invention. FIG. 7(a) is a plan view, FIG. 7(b) is a cross-sectional view showing a cross-section taken along line VIIB-VIIB of FIG. 7(a), and FIG. 7(c) is a cross-sectional view showing a cross-section taken along line VIIC-VIIC of FIG. 7(a). In FIG. 7, reference numbers that are the same as those in FIG. 2 denote the same or corresponding portions.

As shown in FIG. 7, in the membrane-electrode assembly 1 of the present embodiment, the reinforcing member 6 is further provided to extend along the upper side 2a in addition to the membrane-electrode assembly 1 of Embodiment 1. Features other than this are the same as those of Embodiment 1.

Specifically, the reinforcing member 6 is provided to extend along the upper side 2a at a portion corresponding to the upper side 2a in the peripheral portion of the polymer electrolyte membrane 2. The reinforcing members 6 are provided respectively on both surfaces of the polymer electrolyte membrane 2. The catalyst layer 5 is formed such that an upper side thereof contacts the reinforcing member 6. The gas diffusion layer 3 is provided on the catalyst layer 5 and part of the reinforcing member 6.

Next, a method for manufacturing the membrane-electrode assembly constructed as above will be explained.

The method for manufacturing the membrane-electrode assembly of the present embodiment is the same as the method for manufacturing the membrane-electrode assembly of Embodiment 1 from the start to the step of forming a pair of the catalyst layers 5 respectively on both surfaces of the polymer electrolyte membrane 2.

After the step, the reinforcing member 6 is provided on the polymer electrolyte membrane 2 so as to contact the upper side of the catalyst layer 5. Then, the gas diffusion layer 3 is formed on the catalyst layer 5 and part of the reinforcing member 6.

In accordance with the present embodiment explained as above, since the portion corresponding to the upper side 2a in the peripheral portion of the polymer electrolyte membrane 2 is also reinforced, it is possible to further decrease the deterioration of the polymer electrolyte membrane 2. Moreover, since the reinforced portion of the peripheral portion of the polymer electrolyte membrane decreases compared to the case where the peripheral portion of the polymer electrolyte membrane is entirely reinforced, it is possible to efficiently manufacture the membrane-electrode assembly 1.

### Embodiment 4

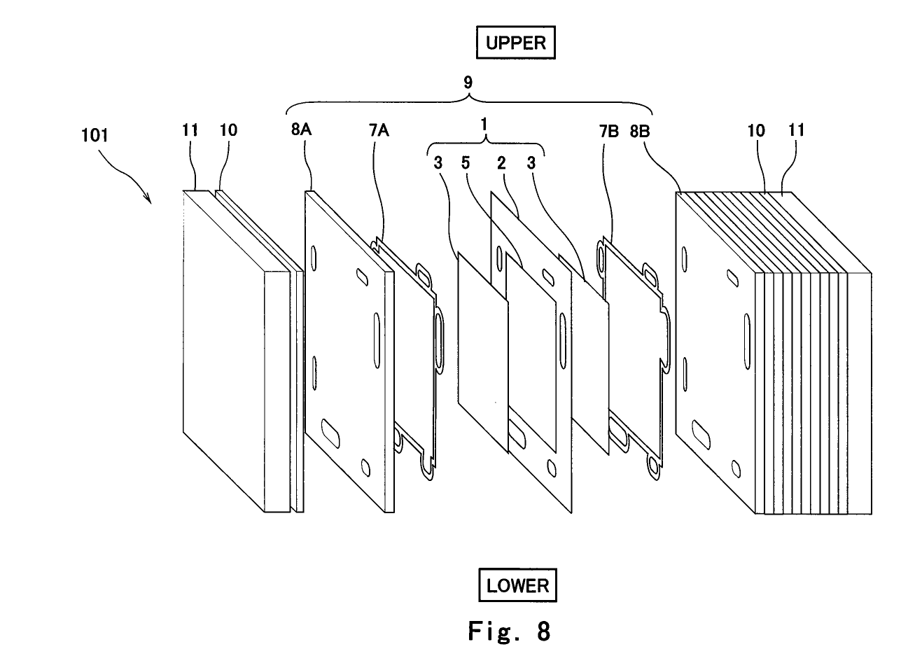

FIG. 8 is a partially exploded perspective view showing the construction of a fuel cell of Embodiment 4 of the present invention. In FIG. 8, reference numbers that are the same as those in FIG. 2 denote the same or corresponding portions.

A fuel cell 101 of the present embodiment is constructed such that a predetermined number of cells 9 are stacked, a current collector 10 and an end plate 11 are provided on each of both ends of the cells 9, and these members are fastened by a rod (not shown) at a predetermined pressure. The cell 9 is constructed such that a pair of gaskets 7A and 7B are provided respectively on the peripheral portions of both surfaces of the membrane-electrode assembly 1, and these members are sandwiched between an anode separator 8A and a cathode separator 8B. The membrane-electrode assembly 1 is constituted of any one of the membrane-electrode assemblies of Embodiments 1 to 3 and Embodiments 5 to 11 described below. In FIG. 8, a cooling water sealing member provided between adjacent cells 9 is not shown.

The present embodiment can obtain the effects described in Embodiments 1 to 3 and effects which will be described in Embodiments 5 to 11.

### Embodiment 5

Embodiment 5 of the present invention exemplifies a membrane-electrode assembly whose three sides are subjected to reinforcing necessary for the parallel flow. In other words, Embodiment 5 of the present invention is a modification example of the membrane-electrode assembly 1 according to Embodiment 4.

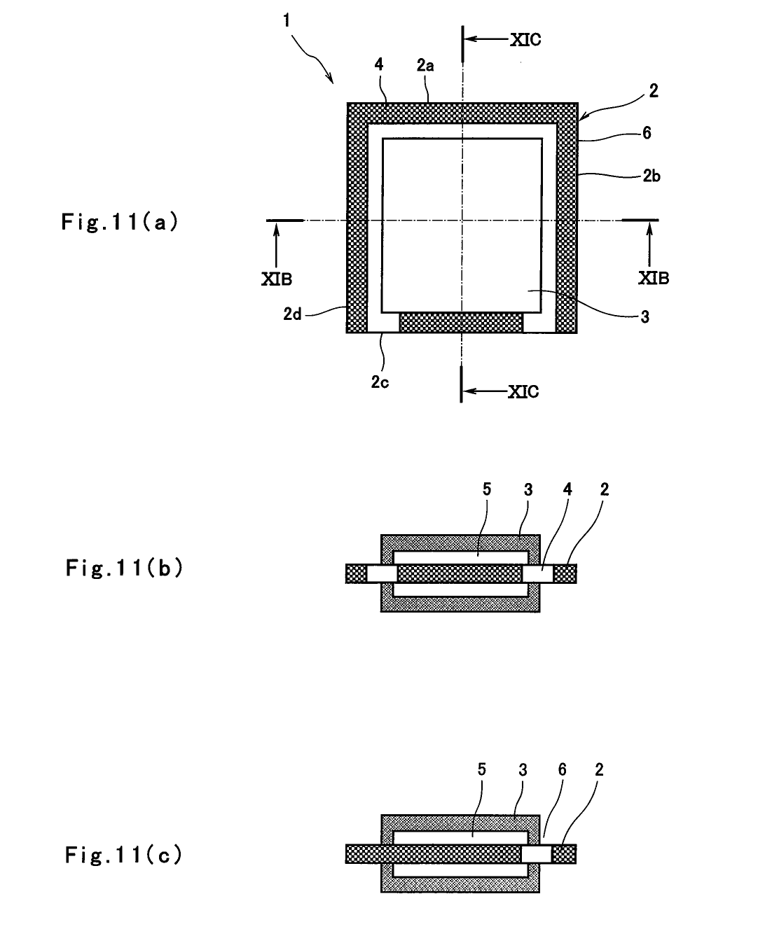

FIG. 11 are diagrams showing the construction of a membrane-electrode assembly of the present embodiment. FIG. 11(a) is a plan view, FIG. 11(b) is a cross-sectional view showing a cross-section taken along line XIB-XIB of FIG. 11(a), and FIG. 11(c) is a cross-sectional view showing a cross-section taken along line XIC-XIC of FIG. 11(a). In FIG. 11, reference numbers that are the same as those in FIG. 2 denote the same or corresponding portions.

As shown in FIG. 11, in the membrane-electrode assembly 1 of the present embodiment, the high-strength portion 4 is further formed to extend along the upper side 2a in addition to the membrane-electrode assembly 1 of Embodiment 1. Features other than this are the same as those of Embodiment 1.

Specifically, the high-strength portion 4 is formed to extend along the upper side 2a, the right side 2b and the left side 2d at the portions corresponding to the upper side 2a, the right side 2b and the left side 2d in the peripheral portion of the polymer electrolyte membrane 2.

To manufacture the membrane-electrode assembly constructed as above, first, the master film of the core is cut to have a predetermined length L in the shape of a rectangular membrane piece. Next, the rectangular membrane piece-shaped core is subjected to punching, so that the through hole non-formed region and the through hole formed region are formed on the membrane piece-shaped core. The through hole non-formed region is formed in the shape of an inverted U along three sides (sides which become the upper side 2a, the right side 2b and the left side 2d of the polymer electrolyte membrane 2 that is a membrane piece) of the membrane piece-shaped core at portions corresponding to the three sides. Then, the same steps as Embodiment 1 are carried out. To be specific, polymer electrolyte layers are formed respectively on both surfaces of the membrane piece-shaped core, and the core is formed into the polymer electrolyte membrane 2 that is the membrane piece. With this, as shown in FIG. 11, the high-strength portion 4 is formed to extend along the upper side 2a, the right side 2b and the left side 2d at the portions corresponding to the upper side 2a, the right side 2b and the left side 2d in the peripheral portion of the polymer electrolyte membrane 2. Next, the catalyst layer 5 and the gas diffusion layer 3 are formed on each of both surfaces of the polymer electrolyte membrane 2. Next, predetermined manifold holes are formed at predetermined positions of the peripheral portion of the polymer electrolyte membrane 2. Thus, the membrane-electrode assembly of the present embodiment is manufactured.

In accordance with the present embodiment, since the portion corresponding to the upper side 2a in the peripheral portion of the polymer electrolyte membrane 2 is also reinforced, it is possible to further decrease the deterioration of the polymer electrolyte membrane 2. Moreover, since the reinforced portion of the peripheral portion of the polymer electrolyte membrane decreases compared to the case where the peripheral portion of the polymer electrolyte membrane is entirely reinforced, it is possible to efficiently manufacture the membrane-electrode assembly 1.

### Embodiment 6

Embodiment 6 of the present invention exemplifies a membrane-electrode assembly whose three sides are subjected to reinforcing necessary for the parallel flow. In other words, Embodiment 6 of the present invention is a modification example of the membrane-electrode assembly 1 according to Embodiment 4.

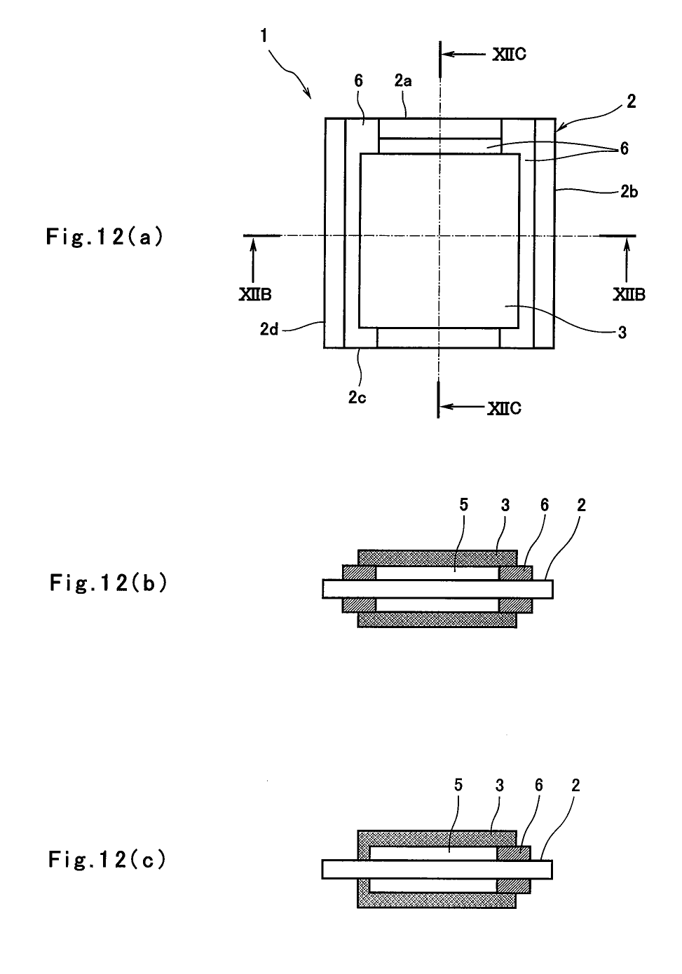

FIG. 12 are diagrams showing the construction of a membrane-electrode assembly of the present embodiment. FIG. 12(a) is a plan view, FIG. 12(b) is a cross-sectional view showing a cross-section taken along line XIIB-XIOIB of FIG. 12(a), and FIG. 12(c) is a cross-sectional view showing a cross-section taken along line XIIC-XIIC of FIG. 12(a). In FIG. 12, reference numbers that are the same as those in FIG. 4 denote the same or corresponding portions.

As shown in FIG. 12, in the membrane-electrode assembly 1 of the present embodiment, the reinforcing member 6 is further provided to extend along the upper side 2a in addition to the membrane-electrode assembly 1 of Embodiment 2. Features other than this are the same as those of Embodiment 2.

Specifically, the reinforcing member 6 is provided to extend along the upper side 2a, the right side 2b and the left side 2d at the portions corresponding to the upper side 2a, the right side 2b and the left side 2d in the peripheral portion of the polymer electrolyte membrane 2. The reinforcing members 6 are provided respectively on both surfaces of the polymer electrolyte membrane 2. Moreover, the method for manufacturing the membrane-electrode assembly constructed as above is the same as the method for manufacturing the membrane-electrode assembly of Embodiment 2 except that three reinforcing members 6 are provided to respectively contact an upper end, left end and right end of each catalyst layer 5 after a pair of the catalyst layers 5 are formed respectively on both surfaces of the membrane piece-shaped polymer electrolyte membrane 2.

In accordance with the present embodiment, since the portion corresponding to the upper side 2a in the peripheral portion of the polymer electrolyte membrane 2 is also reinforced, it is possible to further reduce the deterioration of the polymer electrolyte membrane 2. Moreover, since the reinforced portion of the peripheral portion of the polymer electrolyte membrane decreases compared to the case where the peripheral portion of the polymer electrolyte membrane is entirely reinforced, it is possible to efficiently manufacture the membrane-electrode assembly 1.

### Embodiment 7

Embodiment 7 of the present invention exemplifies a membrane-electrode assembly whose three sides are subjected to reinforcing necessary for the parallel flow. In other words, Embodiment 7 of the present invention is a modification example of the membrane-electrode assembly 1 according to Embodiment 4.

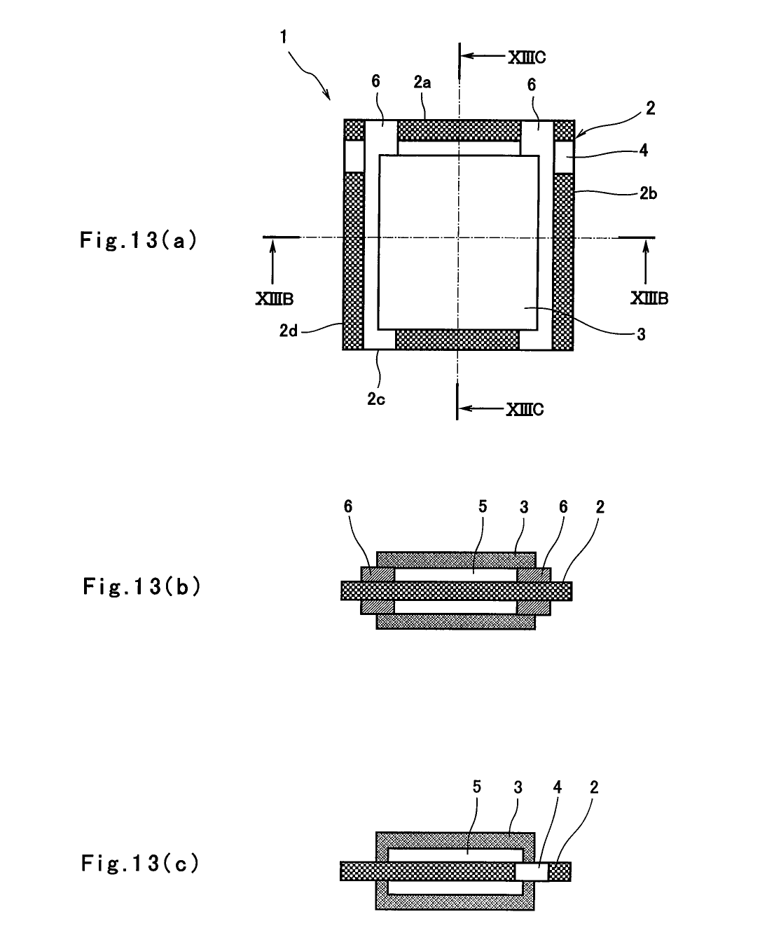

FIG. 13 are diagrams showing the construction of a membrane-electrode assembly of the present embodiment. FIG. 13(a) is a plan view, FIG. 13(b) is a cross-sectional view showing a cross-section taken along line XIIIB-XIIIB of FIG. 13(a), and FIG. 13(c) is a cross-sectional view showing a cross-section taken along line XIIIC-XIIIC of FIG. 13(a). In FIG. 13, reference numbers that are the same as those in FIG. 7 denote the same or corresponding portions.

As shown in FIG. 13, in the membrane-electrode assembly 1 of the present embodiment, the high-strength portion 4 is formed to extend along the upper side 2a at the portion corresponding to the upper side 2a in the peripheral portion of the polymer electrolyte membrane 2 including the core 51 (see FIG. 3), and a pair of the reinforcing members 6 are provided to extend respectively along the left side 2d and the right side 2b at the portions corresponding to the left side 2d and the right side 2b in the peripheral portion of the polymer electrolyte membrane 2 including the core 51. Features other than this are the same as those of Embodiment 3.

A method for manufacturing the membrane-electrode assembly 1 constructed as above will be descried in the following embodiments in detail.

In accordance with the present embodiment as above, since the portion corresponding to the upper side 2a in the peripheral portion of the polymer electrolyte membrane 2 is also reinforced, it is possible to reduce the deterioration of the polymer electrolyte membrane 2. Moreover, since the reinforced portion of the peripheral portion of the polymer electrolyte membrane decreases compared to the case where the peripheral portion of the polymer electrolyte membrane is entirely reinforced, it is possible to efficiently manufacture the membrane-electrode assembly 1.

### Embodiment 8

Embodiments 1 to 7 have exemplified embodiments in a case where the flows of the reaction gases are the parallel flow. Embodiment 8 of the present invention exemplifies an embodiment in a case where the flows of the reaction gases are a counter flow.

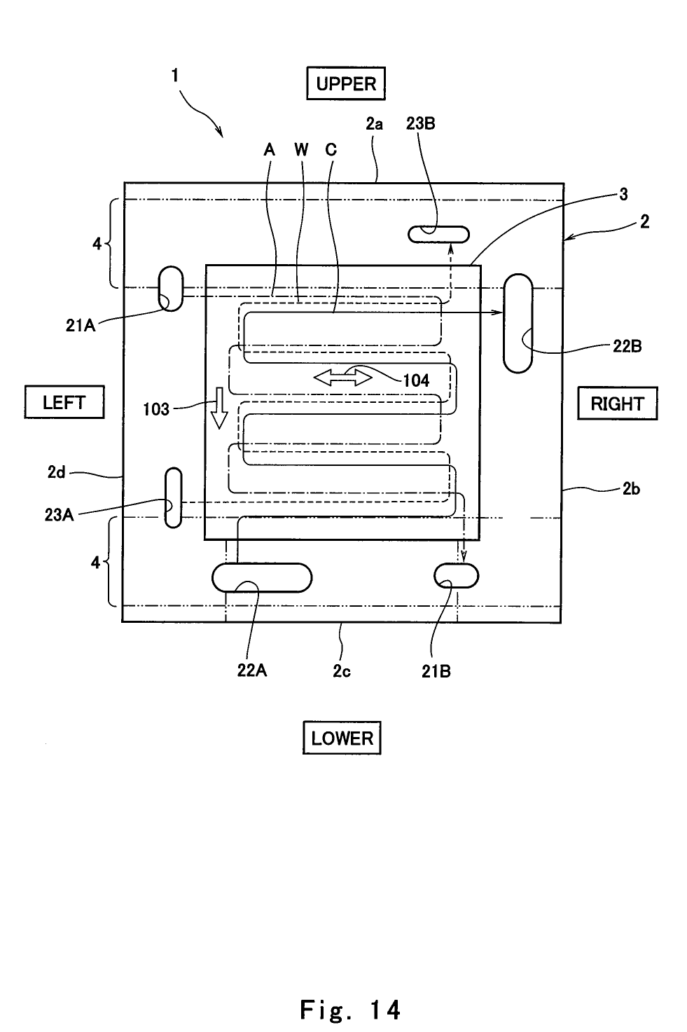

FIG. 14 is a schematic diagram showing a positional relation between reaction gas passages and a cooling water passage of separators and a membrane-electrode assembly of the present embodiment when viewed from a thickness direction of the membrane-electrode assembly. In FIG. 14, reference numbers that are the same as those in FIG. 1 denote the same or corresponding portions.

The following feature of the present embodiment is different from Embodiment 1, and features other than this are the same as those of Embodiment 1. In the present embodiment, as shown in FIG. 14, in the membrane-electrode assembly 1, a pair of the high-strength portions 4 are formed to extend respectively along the upper side 2a and the lower side 2c at the portion corresponding to the upper side 2a and a portion corresponding to the lower side 2c in the peripheral portion of the polymer electrolyte membrane 2.

In the present embodiment, the positions and shapes of the reaction gas passages A and C and the cooling water passage W in a pair of the separators and all manifold holes in the membrane-electrode assembly 1 are the same as those in Embodiment 1. However, first, the cathode gas supplying manifold hole 22A and the cathode gas discharging manifold hole 22B in the membrane-electrode assembly 1 are opposite between the present embodiment and Embodiment 1. To be specific, in the present embodiment, the cathode gas discharging manifold hole 22B in Embodiment 1 is the cathode gas supplying manifold hole 22A, and the cathode gas supplying manifold hole 22A in Embodiment 1 is the cathode gas discharging manifold hole 22B. Therefore, in the cathode separator in the present embodiment, the cathode gas flows in the cathode gas passage C in a direction opposite that of Embodiment 1. As a result, in the present embodiment, when viewed from a thickness direction of the membrane-electrode assembly 1, the cathode gas macroscopically flows in a direction opposite the flow direction of the anode gas. To be specific, in the anode separator, the anode gas passage A in a region contacting the gas diffusion layer 3 is formed to have a serpentine shape extending from upstream to downstream along the right side 2b in a direction from the upper side 2a to the lower side 2c while turning in directions along the upper side 2a of the polymer electrolyte membrane 2, whereas in the cathode separator, the cathode gas passage C in a region contacting the gas diffusion layer 3 is formed to have a serpentine shape extending from upstream to downstream along the left side 2d in a direction from the lower side 2c to the upper side 2a while turning in directions along the lower side 2c of the polymer electrolyte membrane 2. Therefore, the relation between the flow of the anode gas and the flow of the cathode gas is the counter flow.

Secondly, the cooling water supplying manifold hole 23A and the cooling water discharging manifold hole 23B in the membrane-electrode assembly 1 are opposite between the present embodiment and Embodiment 1. To be specific, in the present embodiment, the cooling water discharging manifold hole 23B in Embodiment 1 is the cooling water supplying manifold hole 23A, and the cooling water supplying manifold hole 23A in Embodiment 1 is the cooling water discharging manifold hole 23B. Therefore, in the cathode separator and the anode separator in the present embodiment, the cooling water flows in the cooling water passage W in a direction opposite that of Embodiment 1. As a result, in the present embodiment, when viewed from a thickness direction of the membrane-electrode assembly 1, the cooling water macroscopically flows in a direction opposite the flow direction of the anode gas. Note that the cooling water macroscopically flows in the same direction as the cathode gas.

The present inventors have examined the deterioration of the polymer electrolyte membrane in the case of the counter flow as with the case of the parallel flow. As a result, in the case of the counter flow, it is revealed that the portion corresponding to the upper side 2a and the portion corresponding to the lower side 2c deteriorate the most in the peripheral portion of the rectangular polymer electrolyte membrane 2. The portion corresponding to the upper side 2a is a portion corresponding to an upstream portion (inlet side of the anode gas) of the anode gas passage A, and the portion corresponding to the lower side 2c is a portion corresponding to an upstream portion (inlet side of the cathode gas) of the cathode gas passage C.

In the membrane-electrode assembly 1 of the present embodiment, since the high-strength portions 4 are respectively formed at the portions corresponding to the upper side 2a and the lower side 2c in the peripheral portion of the polymer electrolyte membrane 2, it is possible to prevent these portions from deteriorating.

Next, a method for manufacturing the membrane-electrode assembly 1 of the present embodiment constructed as above will be explained.

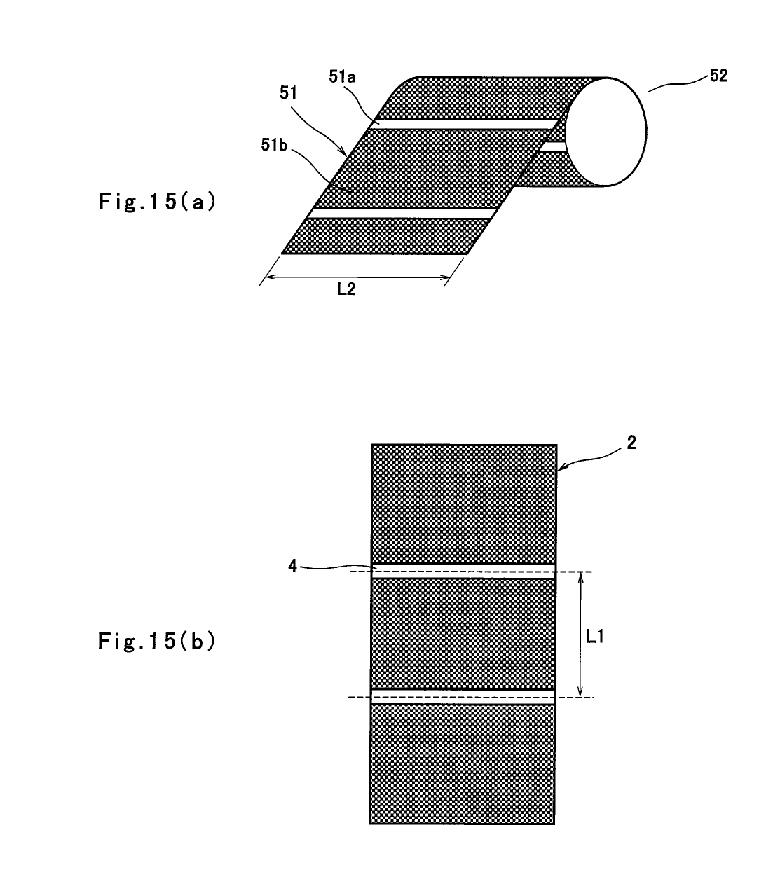

FIGS. 15(a) and 15(b) are schematic diagrams showing steps of manufacturing the membrane-electrode assembly of the present embodiment. In FIGS. 15(a) and 15(b), reference numbers that are the same as those in FIGS. 3(a) and 3(b) denote the same or corresponding portions.

The method for manufacturing the membrane-electrode assembly of the present embodiment is the same as the method for manufacturing the membrane-electrode assembly of Embodiment 1 except for the following feature.

In the present embodiment, as shown in FIG. 15(a), the core 51 is processed (slit) into a master film having the predetermined width L2 corresponding to the width (length of the upper side 2a (lower side 2c)) of the polymer electrolyte membrane piece shown in FIG. 14. Then, the strip-shaped through hole non-formed regions 51a extending in the entire width direction are formed on the master film of the core 51 by punching at a predetermined pitch. The predetermined pitch is a pitch corresponding to the length (length of the left side 2d (right side 2b)) L1 of the polymer electrolyte membrane piece shown in FIG. 14. The punching-processed core 51 is processed into the polymer electrolyte membrane 2 through the same steps as Embodiment 1, and is rolled to be a roll. In the polymer electrolyte membrane 2, the through hole non-formed region 51a of the core 51 is the high-strength portion 4.

Then, as shown in FIG. 15(b), the polymer electrolyte membrane 2 is cut at the high-strength portion 4 while being pulled out from the roll, and thus a membrane piece having the predetermined length L1 is obtained. Thus, the membrane piece-shaped polymer electrolyte membrane 2 is manufactured. By processing the membrane piece-shaped polymer electrolyte membrane 2 in the same manner as Embodiment 1, the membrane-electrode assembly 1 shown in FIG. 14 is manufactured.

In accordance with the method for manufacturing the membrane-electrode assembly of the present embodiment, the high-strength portions 4 necessary for the counter flow can be consecutively formed on the master film of the polymer electrolyte membrane 2 before the master film is cut into the membrane pieces (polymer electrolyte membrane pieces) used for the membrane-electrode assembly 1. Therefore, it is possible to efficiently manufacture the membrane-electrode assembly 1.

Note that the membrane-electrode assembly 1 of the present embodiment can be manufactured by the method for manufacturing the membrane-electrode assembly of Embodiment 1. In this case, in FIG. 3(a), a predetermined width of the core 51 is set to the length L1 of the polymer electrolyte membrane (membrane piece) 2 shown in FIG. 14, and in FIG. 3(b), the polymer electrolyte membrane 2 is cut to have the length L2 corresponding to the width of the polymer electrolyte membrane (membrane piece) 2 shown in FIG. 14.

In contrast, the method for manufacturing the membrane-electrode assembly of the present embodiment is applicable to the method for manufacturing the membrane-electrode assembly of Embodiment 1. In this case, in FIGS. 15(a) and 15(b), a predetermined width of the core 51 is set to the length L1 of the polymer electrolyte membrane (membrane piece) 2 shown in FIG. 1, and the pitch of the high-strength portion 4 is set to the width L2 of the polymer electrolyte membrane (membrane piece) 2 shown in FIG. 1.

### Embodiment 9

Embodiment 9 of the present invention exemplifies an embodiment in a case where the flows of the reaction gases are a cross flow.

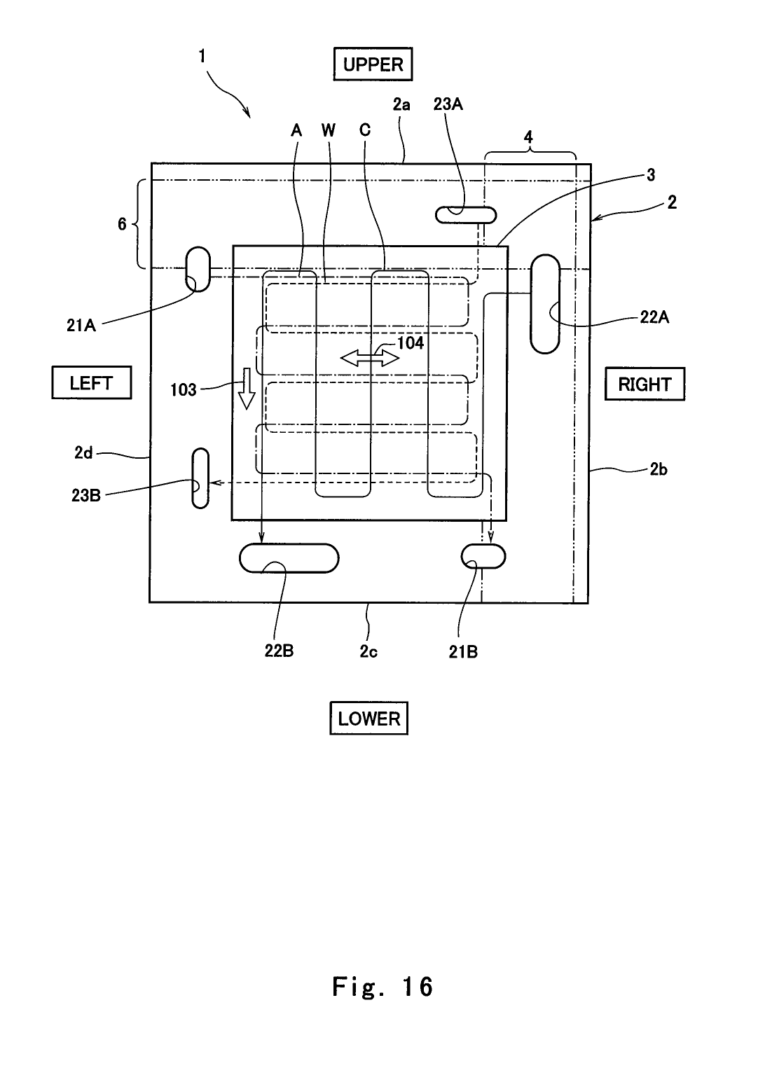

FIG. 16 is a schematic diagram showing a positional relation between reaction gas passages and a cooling water passage of separators and a membrane-electrode assembly of the present embodiment when viewed from a thickness direction of the membrane-electrode assembly. In FIG. 16, reference numbers that are the same as those in FIG. 1 denote the same or corresponding portions.

The following feature of the present embodiment is different from Embodiment 1, and features other than this are the same as those of Embodiment 1. In the present embodiment, as shown in FIG. 16, in the membrane-electrode assembly 1, the high-strength portion 4 is formed to extend along the right side 2b at the portion corresponding to the right side 2b in the peripheral portion of the polymer electrolyte membrane 2, and the reinforcing member 6 is provided to extend along the upper side 2a at the portion corresponding to the upper side 2a.

In the present embodiment, the positions and shapes of the anode gas passage A and the cooling water passage W in a pair of the separators and all manifold holes in the membrane-electrode assembly 1 are the same as those in Embodiment 1. However, the cathode gas passage C in the cathode separator is different from that of Embodiment 1, and is formed to be macroscopically orthogonal to the anode gas passage A when viewed from a thickness direction of the membrane-electrode assembly 1. To be specific, the relation between the flow of the anode gas and the flow of the cathode gas is the cross flow. Specifically, the cathode gas passage C is formed to microscopically repeat a section which extends in a direction orthogonal to the lateral direction (direction along the upper side 2a and the lower side 2c) 104, that is, the vertical direction (direction along the right side 2b and the left side 2d) 103 for a predetermined distance, turns there, extends from there in a direction opposite the above direction along the vertical direction for a predetermined distance and turns there, and macroscopically extend in the lateral direction 104. In contrast, the anode gas passage A is formed to macroscopically extend in the vertical direction 103, so that the anode gas passage A and the cathode gas passage C are macroscopically orthogonal to each other.

Next, a method for manufacturing the membrane-electrode assembly 1 of the present embodiment constructed as above will be explained.

The present inventors have examined the deterioration of the polymer electrolyte membrane in the case of the cross flow as with the case of the parallel flow. As a result, in the case of the cross flow, it is revealed that the portion corresponding to the upper side 2a and the portion corresponding to the right side 2b deteriorate the most in the peripheral portion of the rectangular polymer electrolyte membrane 2. The portion corresponding to the upper side 2a is a portion corresponding to the upstream portion (inlet side of the anode gas) of the anode gas passage A, and the portion corresponding to the right side 2b is a portion corresponding to the upstream portion (inlet side of the cathode gas) of the cathode gas passage C.

In the membrane-electrode assembly 1 of the present embodiment, since the reinforcing member 6 is provided at the portion corresponding to the upper side 2a in the peripheral portion of the polymer electrolyte membrane 2, and the high-strength portion 4 is formed at the portion corresponding to the right side 2b in the peripheral portion of the polymer electrolyte membrane 2, it is possible to prevent these portions from deteriorating.

Next, a method for manufacturing the membrane-electrode assembly 1 of the present embodiment constructed as above will be explained.

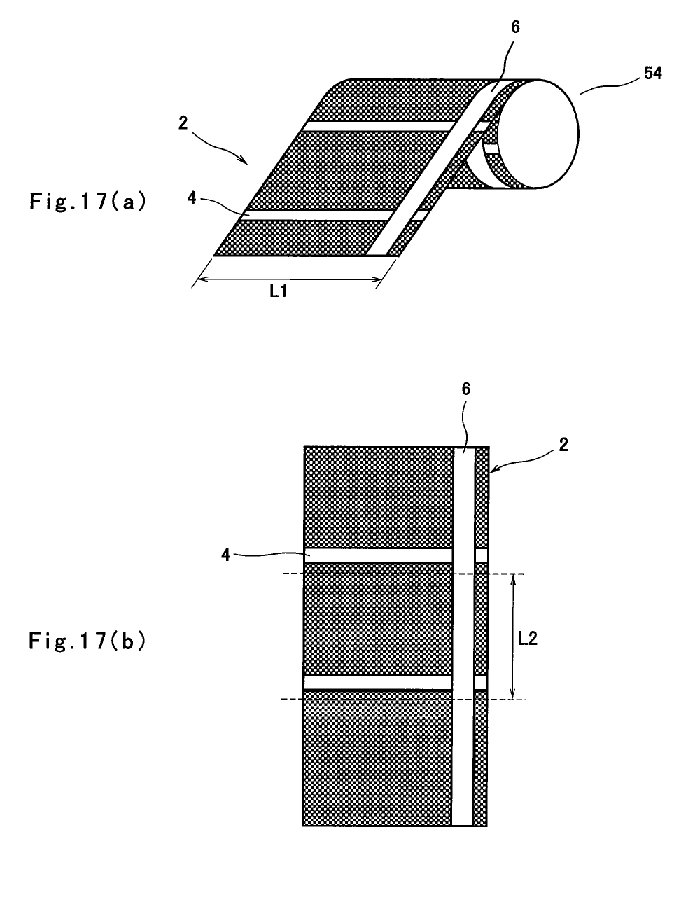

FIGS. 17(a) and 17(b) are schematic diagrams showing steps of manufacturing the membrane-electrode assembly of the present embodiment. In FIGS. 17(a) and 17(b), reference numbers that are the same as those in FIGS. 15(a) and 15(b) denote the same or corresponding portions.

The method for manufacturing the membrane-electrode assembly of the present embodiment is the same as the method for manufacturing the membrane-electrode assembly of Embodiment 1 except for the following feature.

In the present embodiment, first, the polymer electrolyte membrane is manufactured as follows. This step is the same as Embodiment 8 except that the width of the core (which will be the polymer electrolyte membrane) to be manufactured and the pitch of the through hole non-formed regions (which will be the reinforced portions) are different. Therefore, this step will be explained with reference to FIG. 15(a). In FIG. 15(a), the core 51 is processed (slit) into a master film having the predetermined width L1 corresponding to the length (length of the left side 2d (right side 2b)) of the polymer electrolyte membrane piece shown in FIG. 16. Then, the strip-shaped through hole non-formed regions 51a extending in the entire width direction are formed on the master film of the core 51 by punching at a predetermined pitch. The predetermined pitch is a pitch corresponding to the width (length of the upper side 2a (lower side 2c)) L2 of the polymer electrolyte membrane piece shown in FIG. 16. The punching-processed core 51 is processed into the polymer electrolyte membrane 2 through the same steps as Embodiment 1, and is rolled to be the roll 52. In the polymer electrolyte membrane 2, the through hole non-formed region 51a of the core 51 is the high-strength portion 4.

Next, as shown in FIG. 17(a), the tape-shaped reinforcing members 6 are attached respectively to both surfaces of the master film of the polymer electrolyte membrane 2 along one side end of the master film. As is well known, the reinforcing members 6 are bonded by, for example, pulling out the master film of the polymer electrolyte membrane 2 from the roll, supplying the tape-shaped reinforcing members 6 respectively to both surfaces of the pulled-out polymer electrolyte membrane 2, and causing these members to pass through between a pair of pressure rollers. The master film of the polymer electrolyte membrane 2 to which the reinforcing member 6 is bonded is rolled to be a roll 54.

Then, as shown in FIG. 17(b), the master film of the polymer electrolyte membrane 2 is cut at a portion immediately after the high-strength portion 4 while being pulled out from the roll 54, and thus a membrane piece having the predetermined length L2 is obtained. Thus, the membrane piece-shaped polymer electrolyte membrane 2 is manufactured. Then, the membrane piece-shaped polymer electrolyte membrane 2 is processed in the same manner as Embodiment 1. Thus, the membrane-electrode assembly 1 shown in FIG. 16 is manufactured.

In accordance with the method for manufacturing the membrane-electrode assembly of the present embodiment, since the high-strength portion 4 necessary for the counter flow can be formed consecutively on the master film of the polymer electrolyte membrane 2 and the reinforcing member 6 can be provided before cutting into the membrane pieces (polymer electrolyte membrane pieces) used for the membrane-electrode assembly 1, it is possible to efficiently manufacture the membrane-electrode assembly 1.

### Embodiment 10

Embodiment 10 of the present invention exemplifies a method for efficiently manufacturing a membrane-electrode assembly whose three sides are subjected to reinforcing necessary for the parallel flow. In other words, Embodiment 10 of the present invention is a modification example of the method for manufacturing the membrane-electrode assembly 1 according to Embodiment 3.

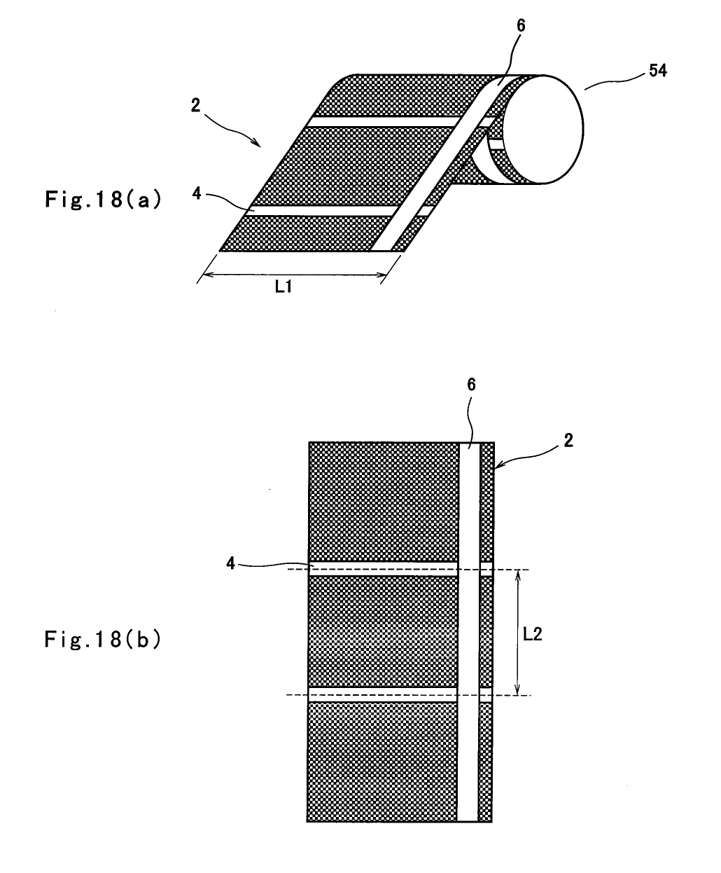

FIGS. 18(a) and 18(b) are schematic diagrams showing steps of manufacturing the membrane-electrode assembly according to Embodiment 10 of the present invention. In FIGS. 18(a) and 18(b), reference numbers that are the same as those in FIGS. 17(a) and 17(b) denote the same or corresponding portions.

As shown in FIG. 18(a), the method for manufacturing the membrane-electrode assembly of the present embodiment is the same as the method for manufacturing the membrane-electrode assembly of Embodiment 9 from the start to the step of forming the roll 54 of the polymer electrolyte membrane 2 to which the reinforcing member 6 is bonded.

In the present embodiment, as shown in FIG. 18(b), the master film of the polymer electrolyte membrane 2 is cut at the high-strength portion 4 while being pulled out from the roll 54, and thus the membrane piece having the predetermined length L2 is obtained. Thus, the membrane piece-shaped polymer electrolyte membrane 2 is manufactured. Then, the membrane piece-shaped polymer electrolyte membrane 2 is processed in the same manner as Embodiment 3. Thus, the membrane-electrode assembly 1 shown in FIG. 7 is manufactured.

In accordance with the method for manufacturing the membrane-electrode assembly of the present embodiment, since the high-strength portion 4 can be formed consecutively on the master film of the polymer electrolyte membrane 2 and the reinforcing member 6 can be provided before cutting into the membrane pieces (polymer electrolyte membrane pieces) used for the membrane-electrode assembly 1, it is possible to efficiently manufacture the membrane-electrode assembly 1 whose three sides are subjected to reinforcing necessary for the parallel flow.

### Embodiment 11

Embodiment 11 of the present invention shows a method for manufacturing the membrane-electrode assembly 1 according to Embodiment 3.

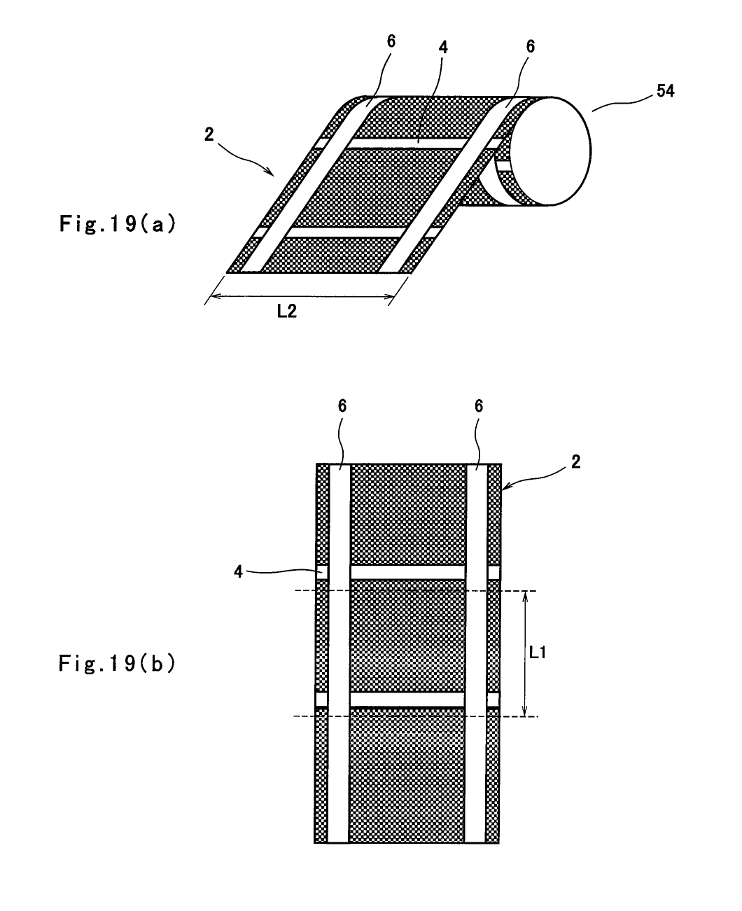

FIGS. 19(a) and 19(b) are schematic diagrams showing steps of manufacturing the membrane-electrode assembly of the present embodiment. In FIGS. 19(a) and 19(b), reference numbers that are the same as those in FIGS. 3(a) and 3(b) denote the same or corresponding portions.

The method for manufacturing the membrane-electrode assembly of the present embodiment is the same as the method for manufacturing the membrane-electrode assembly of Embodiment 1 except for the following feature.

In the present embodiment, first, the polymer electrolyte membrane is manufactured as follows. This step is the same as Embodiment 8. Therefore, this step will be explained with reference to FIG. 15(a). In FIG. 15(a), the core 51 is processed (slit) into a master film having the predetermined width L2 corresponding to the width (length of the upper side 2a (lower side 2c)) of the polymer electrolyte membrane piece shown in FIG. 13. Then, the strip-shaped through hole non-formed regions 51a extending in the entire width direction are formed on the master film of the core 51 by punching at a predetermined pitch. The predetermined pitch is a pitch corresponding to the length (length of the right side 2b (left side 2d)) L1 of the polymer electrolyte membrane piece shown in FIG. 13. The punching-processed core 51 is processed into the polymer electrolyte membrane 2 through the same steps as Embodiment 1, and is rolled to be the roll 52. In the polymer electrolyte membrane 2, the through hole non-formed region 51a of the core 51 is the high-strength portion 4.

Next, as shown in FIG. 19(a), two pairs of tape-shaped reinforcing members 6 are bonded respectively to both surfaces of the master film of the polymer electrolyte membrane 2 along both side ends of the master film. As is well known, the reinforcing members 6 are bonded by, for example, pulling out the master film of the polymer electrolyte membrane 2 from the roll, supplying the two pairs of tape-shaped reinforcing members 6 respectively to both surfaces of the pulled-out polymer electrolyte membrane 2, and causing these members to pass through between a pair of pressure rollers. The master film of the polymer electrolyte membrane 2 to which the reinforcing member 6 is bonded is rolled to be the roll 54.

Then, as shown in FIG. 19(b), the master film of the polymer electrolyte membrane 2 is cut at a portion immediately after the high-strength portion 4 while being pulled out from the roll 54, and thus a membrane piece having the predetermined length L1 is obtained. Thus, the membrane piece-shaped polymer electrolyte membrane 2 is manufactured. Then, the membrane piece-shaped polymer electrolyte membrane 2 is processed in the same manner as Embodiment 1. Thus, the membrane-electrode assembly 1 shown in FIG. 13 is manufactured.

In accordance with the method for manufacturing the membrane-electrode assembly of the present embodiment, since the high-strength portion 4 can be formed consecutively on the master film of the polymer electrolyte membrane 2 and the reinforcing member 6 can be provided before cutting into the membrane pieces (polymer electrolyte membrane pieces) used for the membrane-electrode assembly 1, it is possible to efficiently manufacture the membrane-electrode assembly 1 whose three sides are subjected to reinforcing necessary for the parallel flow.

In the above embodiments, each of the high-strength portion 4 and the reinforcing member 6 each of which is provided to extend over the entire width or length of the membrane piece of the polymer electrolyte membrane 2 may be provided to extend over part of the entire width or length of the membrane piece of the polymer electrolyte membrane 2.

From the foregoing explanation, many modifications and other embodiments of the present invention are obvious to one skilled in the art. Therefore, the foregoing explanation should be interpreted only as an example, and is provided for the purpose of teaching the best mode for carrying out the present invention to one skilled in the art. The structures and/or functional details may be substantially modified within the spirit of the present invention.

### INDUSTRIAL APPLICABILITY

A membrane-electrode assembly of the present invention is useful as a membrane-electrode assembly which can be efficiently manufactured.

A fuel cell of the present invention is useful as a fuel cell including a membrane-electrode assembly which can be efficiently manufactured.

A method for manufacturing a membrane-electrode assembly of the present invention is useful as a method for manufacturing a membrane-electrode assembly whose producibility is excellent.

1. A membrane-electrode assembly comprising: a quadrate polymer electrolyte membrane; a pair of catalyst layers provided to sandwich the polymer electrolyte membrane except for a peripheral portion of the polymer electrolyte membrane; and a pair of electrically-conductive gas diffusion layers provided respectively on the pair of the catalyst layers, the membrane-electrode assembly being incorporated into a fuel cell by being sandwiched between a pair of separators on each of which a reaction gas passage is concavely formed in a gas diffusion layer contacting region of an inner surface thereof, the gas diffusion layer contacting region being a region contacting the gas diffusion layer, wherein:
on each of the separators, the reaction gas passage in the gas diffusion layer contacting region is formed to have a serpentine shape which extends from upstream to downstream in a direction from a side (hereinafter referred to as “first side”) of the polymer electrolyte membrane to a side (hereinafter referred to as “third side”) facing the first side along a side (hereinafter referred to as “second side”) adjacent to the first side while turning in directions along the first side; and
reinforced portions for reinforcing the polymer electrolyte membrane are formed at a portion corresponding to the second side and a portion corresponding to a side (hereinafter referred to as “fourth side”) facing the second side in the peripheral portion of the polymer electrolyte membrane such that the reinforced portions respectively extend along the second side and the fourth side to have strip shapes, and the reinforced portion is not formed at a portion corresponding to at least the third side in the peripheral portion of the polymer electrolyte membrane.

2. The membrane-electrode assembly according to claim 1, wherein the reinforced portions are formed only at the portion corresponding to the second side and the portion corresponding to the fourth side in the peripheral portion of the polymer electrolyte membrane.

3. The membrane-electrode assembly according to claim 1, wherein the reinforced portion is further formed at a portion corresponding to the first side in the peripheral portion of the polymer electrolyte membrane.

4. The membrane-electrode assembly according to claim 1, wherein:
the polymer electrolyte membrane includes a membrane-like core on which a large number of through holes are formed and polymer electrolyte layers formed respectively on both surfaces of the core so as to fill the through holes; and
the reinforced portions are constituted of high-strength portions each of which is formed by forming the polymer electrolyte layer on a region of the core on which region the through holes are not formed.

5. The membrane-electrode assembly according to claim 1, wherein the reinforced portion is constituted of reinforcing members provided respectively on both surfaces of the polymer electrolyte membrane.

6. The membrane-electrode assembly according to claim 4, wherein:
the reinforced portions formed at the portion corresponding to the second side and the portion corresponding to the fourth side in the peripheral portion of the polymer electrolyte membrane are constituted of the high-strength portions; and
the reinforced portion is formed at the portion corresponding to the first side in the peripheral portion of the polymer electrolyte membrane such that reinforcing members are provided respectively on both surfaces of the polymer electrolyte membrane.

7. A fuel cell comprising a plurality of stacked cells, each cell including:
a membrane-electrode assembly having:
a quadrate polymer electrolyte membrane;
a pair of catalyst layers provided to sandwich the polymer electrolyte membrane except for a peripheral portion of the polymer electrolyte membrane; and
a pair of electrically-conductive gas diffusion layers provided respectively on the pair of the catalyst layers; and
a pair of separators on each of which a reaction gas passage is concavely formed in a gas diffusion layer contacting region of an inner surface thereof and which sandwich the membrane-electrode assembly such that the gas diffusion layer contacting region contacts the gas diffusion layer, wherein:
on each of the separators, the reaction gas passage in the gas diffusion layer contacting region is formed to have a serpentine shape which extends from upstream to downstream in a direction from a side (hereinafter referred to as “first side”) of the polymer electrolyte membrane to a side (hereinafter referred to as “third side”) facing the first side along a side (hereinafter referred to as “second side”) adjacent to the first side while turning in directions along the first side; and
reinforced portions for reinforcing the polymer electrolyte membrane are formed at a portion corresponding to the second side and a portion corresponding to a side (hereinafter referred to as “fourth side”) facing the second side in the peripheral portion of the polymer electrolyte membrane such that the reinforced portions respectively extend along the second side and the fourth side to have strip shapes, and the reinforced portion is not formed at a portion corresponding to at least the third side in the peripheral portion of the polymer electrolyte membrane.

8. A method for manufacturing a membrane-electrode assembly including: a quadrate polymer electrolyte membrane; a pair of catalyst layers provided to sandwich the polymer electrolyte membrane except for a peripheral portion of the polymer electrolyte membrane; and a pair of electrically-conductive gas diffusion layers provided respectively on the pair of the catalyst layers, the method comprising the steps of:
preparing an elongate membrane-like core having a predetermined width;
forming, on the core, a through hole formed region where a through hole penetrating the core in a thickness direction of the core is formed and a through hole non-formed region where the through hole is not substantially formed such that the through hole non-formed region forms a pair of strips respectively extending along both ends of the core, and the through hole formed region is located at a portion other than the through hole non-formed region;
forming polymer electrolyte layers respectively on both surfaces of the core on which the through hole non-formed region and the through hole formed region are formed such that the polymer electrolyte layer fills the through hole, and forming an elongate polymer electrolyte membrane having a pair of high-strength portions which are formed by forming the polymer electrolyte layers respectively on the pair of the through hole non-formed regions;
cutting the elongate polymer electrolyte membrane to form a membrane piece-shaped polymer electrolyte membrane having a predetermined length; and
forming the pair of the catalyst layers and the pair of the gas diffusion layers respectively on both surfaces of the membrane piece-shaped polymer electrolyte membrane such that at least part of the catalyst layers and at least part of the gas diffusion layers are located between the pair of the high-strength portions.

9. A method for manufacturing a membrane-electrode assembly including: a quadrate polymer electrolyte membrane; a pair of catalyst layers provided to sandwich the polymer electrolyte membrane except for a peripheral portion of the polymer electrolyte membrane; and a pair of electrically-conductive gas diffusion layers provided respectively on the pair of the catalyst layers, the method comprising the steps of:
(A) preparing an elongate membrane-like core having a predetermined width;
(B) forming, on the core, through hole formed regions where a through hole penetrating the core in a thickness direction of the core is formed and through hole non-formed regions where the through hole is not substantially formed such that the through hole non-formed regions extend in a width direction of the core so as to have a strip shape, the through hole non-formed regions are arranged at a predetermined pitch in a longitudinal direction of the core, and the through hole formed regions are arranged at portions other than the through hole non-formed regions;
(C) forming polymer electrolyte layers respectively on both surfaces of the core on which the through hole non-formed regions and the through hole formed regions are formed such that the polymer electrolyte layer fills the through hole, and forming an elongate polymer electrolyte membrane having a plurality of high-strength portions which are formed by forming the polymer electrolyte layers on the plurality of the through hole non-formed regions;
(D) cutting the elongate polymer electrolyte membrane at the plurality of the high-strength portions to form membrane piece-shaped polymer electrolyte membranes each of which includes a pair of the high-strength portions respectively at a pair of sides each having a length corresponding to the predetermined pitch and formed by the above cutting; and
(E) forming the pair of the catalyst layers and the pair of the gas diffusion layers respectively on both surfaces of the membrane piece-shaped polymer electrolyte membrane such that at least part of the catalyst layers and at least part of the gas diffusion layers are located between the pair of the high-strength portions.

10. The method according to claim 9, further comprising the step of:
(F) between the steps (C) and (D), providing a tape-shaped reinforcing member along at least one side end of the polymer electrolyte membrane, wherein:
in the step (D), by cutting the elongate polymer electrolyte membrane at the plurality of the high-strength portions, the membrane piece-shaped polymer electrolyte membranes are formed, each of which includes a pair of the high-strength portions respectively at a pair of sides each having a length corresponding to the predetermined pitch and formed by the above cutting and also includes the reinforcing member which is provided along a side between the pair of the sides and both of whose ends are cut; and
in the step (E), the pair of the catalyst layers and the pair of the gas diffusion layers are formed respectively on both surfaces of the membrane piece-shaped polymer electrolyte membrane such that at least part of the catalyst layers and at least part of the gas diffusion layers are located among the pair of the high-strength portions and the reinforcing member.

11. (canceled)
